(19) United States
(12) Patent Application Publication
(10) Pub. No.: US 2026/0278255 A1
(43) Pub. Date: Sep. 17, 2026

(54) Automatically Generating a Report using Audio Data

(71) Applicant: Axon Enterprise, Inc., Scottsdale, AZ (US)

(72) Inventors: Noah Spitzer-Williams, Long Beach, CA (US); Michael Bryan Wheeler, Redmond, WA (US); Yasser Ibrahim, Redmond, WA (US); Patrick W. Smith, Scottsdale, AZ (US); Mark B. Cusick, Wake Forest, NC (US); Austin Moon, West Jordan, UT (US); Matthew R. Powell, Renton, WA (US); Catherine Grabar, Port Orchard, WA (US)

(21) Appl. No.: 19/676,746

(22) Filed: May 13, 2026

Related U.S. Application Data
(63) Continuation of application No. PCT/US24/55797, filed on Nov. 13, 2024.
(60) Provisional application No. 63/598,542, filed on Nov. 13, 2023.
(60) Provisional application No. 63/637,870, filed on Apr. 23, 2024.

(51) Int. Cl. G06F 40/166; G06Q 50/26

(52) U.S. Cl. CPC G06F 40/166; G06Q 50/265

(57) ABSTRACT

Methods, systems, and devices are provided for automatically generating a report for an incident or event. The report may be automatically generated by a generative computing device. The report may be automatically generated in response to a prompt. The prompt may include one or more sample reports. The prompt may be automatically generated. The prompt may include predetermined instructions for generating the report. The prompt may include a transcript. The transcript may be generated by transcribing audio data captured at an event. The automatically generated report may be provided for display. Providing the report for display may include linking portions of the generated report to audio data upon which the report is generated. Providing the report may include inserting verification information in the automatically generated report.

### FIELD OF THE INVENTION

Embodiments according to various aspects of the present disclosure relate to systems, methods, and/or devices usable to generate reports using audio data captured at an incident.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a system for automatically generating a report using event data, in accordance with various embodiments described herein;

FIG. 2 illustrates a device automatically generating a report using event data, in accordance with various embodiments described herein;

FIG. 3 illustrates a method for automatically generating a report in accordance with various embodiments described herein;

FIG. 4 illustrates a user interface for an automatically generated report in accordance with various embodiments described herein;

FIG. 5 illustrates a method for generating a prompt in accordance with various embodiments described herein;

FIG. 6 illustrates a data store for generating a prompt in accordance with various embodiments described herein;

FIG. 7 illustrates a method for verifying a report has been provided in accordance with various embodiments described herein; and

FIG. 8 illustrates a user interface for an automatically generated report in accordance with various embodiments described herein.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Information may be captured by one or more recording devices (e.g., cameras, body cameras, vehicle-mounted cameras, audio recording devices, drone-mounted recording devices, etc.) at an incident (e.g., event). A report may be later generated regarding the incident. The report may require information in a predetermined format. The predetermined format may require, for example, a specific order and/or set of text data. In embodiments according to various aspects of the present disclosure, a report may be automatically generated in accordance with the information captured by the one or more recording devices. The report may be further provided in the predetermined format to efficiently and accurately complete the report.

In embodiments, combining recording devices and other sensors with advanced and automatic processing techniques presents an opportunity to automate a large portion of incident documentation. Recording devices and other sensors may capture a high volume of unstructured data. This unstructured data may be reduced to specific information in a predetermined format for a structured report. This unstructured data may be filtered to remove redundant or unnecessary information from the final report. Relying on information captured by recording devices reduces the number of inputs necessary to generate a structured report and precludes the need for redundant information to be received by a records management system. Embodiments according to various aspects of the present disclosure address this technology-based issue by automatically generating one or more portions (e.g., segments) of a report based on unstructured data captured by one or more recording devices. Automatically generating the report may comprise generating structured data for the one or more portions of the report based on unstructured data captured by one or more recording devices. Alternately or additionally, automatically generating the report may comprise linking structured report data with parts of information on which the structured report data was generated. Such linking may enable verification of the structured data relative to the unstructured data.

A report comprises data relating to an incident. A report may document facts surrounding a response by a responder (e.g., law enforcement officer, security personnel, etc.) to a single incident. A report may comprise logically structured data for the incident. A logical structure of the logically structured data may comprise sets of data relating to different facts of the incident. The sets of data may relate to what happened (e.g., occurred) during an incident, what or who was involved with the incident, and when the incident occurred. In embodiments, a report may include an incident type, one or more entities involved with the incident, and at least one narrative portion. In embodiments, an incident type, one or more entities involved with the incident, and at least one narrative portion may each correspond to a part or element of the structured report. For example, the incident type may relate to what happened during the incident and when the incident occurred, the one or more entities may relate to who or what is involved with the incident, and the at least one narrative portion may be related to what happened during the incident. In embodiments, a report may comprise an incident report. The incident report may be associated with one or more of a public safety response or a security incident.

An incident type may describe an action. For example, an incident type may include an activity such as a theft, burglary, vagrancy, trespassing, assault, robbery, among others. An incident may include an incident code associated with each type of incident. An incident type may indicate a location at which the incident occurred or may have occurred. Information indicating an incident type may be included in a report. In embodiments, an incident type may include an offense.

One or more entities may be involved in an incident. An entity may include a person involved with an incident. For example, a person may include one or more of a responder, a victim, a suspect, and a witness. An entity may include a physical object involved with an incident. A physical object may include one or more of a vehicle, weapon, building, an item of personal property, an item of public property, and other physical items. A physical object may include evidence associated with an incident. Evidence associated with an incident may include electronic information generated responsive to and/or at an incident.

A report may include data related to the one or more entities associated with the incident. The data may provide information about the one or more entities. For example, a report relating to a burglary may include a person entity associated with the victim of the incident and a person entity associated with a suspect that may have committed the burglary. Such a report may also include entities associated with each item of property involved with the burglary, such as a building or vehicle.

A report may include a narrative portion. A narrative portion may include text data that describes relationships, actions, and sequences of actions between entities at the incident. A narrative may summarize an event reflected in the report. A narrative may comprise a filtered set of information relative to an overall set of information recorded for an incident. A narrative may comprise a reformatted and/or reorganized set of information relative to an initial set of information recorded for an incident. A narrative portion may indicate when an incident occurred. A narrative portion may include information identifying a responder that responded to the incident. For example, the narrative portion may indicate a name of the responder that responded to the incident.

A report may have a predetermined format. For example, a narrative portion may include one or more predetermined fields for completion. A narrative portion may include a predetermined style of writing. For example, a narrative portion may comprise a predetermined perspective and/or verb tense. The narrative portion may comprise a predetermined order of information. For example, a narrative portion may require a different order of information relative to an order in which information is captured chronologically in audio data.

A report may be portable. For example, a report may be printed or combined into a single file. The file may be a digital file. A report may be viewed and/or transported between different computing devices. A report may be viewable within a single browser, program, window, or other user interface element. A report may be viewable, displayed, or otherwise output by a single computing device. In embodiments, a report may include a copy of each set of text data and/or structured data included in the report.

A report may be verifiable. Each set of data in a report may be traced back to a source of information. For example, a narrative portion may be traced back to an audio file from which content of the narrative portion may be generated. Secondary data may be included in the report that indicates one or more sources for each set of data in a report.

In embodiments, a report may comprise filtered information. For example, information recorded in event data may identify a variety of different objects located at a location of an incident. However, only a subset of these objects may be associated with the incident that occurred at the location. In accordance with various embodiments, a report may comprise filtered information in which information identifying objects associated with the incident is retained, but information identifying objects not associated with the incident is removed. The filtered information may summarize information recorded in event information, whereby information related to an incident is included, but information unrelated to the incident is excluded. In some embodiments, the filtered information may further remove duplicate information recorded in event information. Such filtered information may enable efficient, subsequent review of information associated with an incident.

Embodiments according to various aspects of the present disclosure provide various technical improvements to recording systems. Technical improvements may be particularly provided to systems comprising recording devices, such as, but not limited to, evidence management systems, records management systems, or other computer-based systems. For example, a recording device may capture event data associated with an incident. The event data may indicate information associated with the event. The event data may comprise audio data in which the information is recorded as audible information and/or video data in which the information is recorded as visual information. An evidence management system or records management may require information associated with an incident to be provided as text data. Alternately or additionally, event data may compress excess information that may be unrelated to an incident. Alternately or additionally, the event data may comprise an incomplete set of information regarding an incident. Embodiments according to various aspects of the present disclosure prevent information that has been previously recorded in event data from needing to be recaptured for a report. Embodiments according to various aspects of the present disclosure enable information that was captured in event data to be reused to generate a report. By enabling further use of previously recorded information, a report associated with an incident may be generated in less time compared with other forms of report generation. Such an arrangement may preclude a need for separate review of the recorded event data prior to subsequent generation of a report. For example, playback of video data, or at least an entire set of video data, may be avoided in accordance with various aspects of the present disclosure. By employing previously recorded event data, accuracy of a report may be increased relative to other, additional sources of information. Moreover, by employing event data captured by a recording device to serve as a basis of a subsequently generated report, functionality of a system comprising the recording device may be increased. Such an arrangement may provide particular technical benefits to incident reports related to law enforcement activity, where information associated with an incident may be gathered in an unstructured manner over an extended period of time, but a corresponding report may be generated accurately and efficiently based on this same information by a generative computing device.

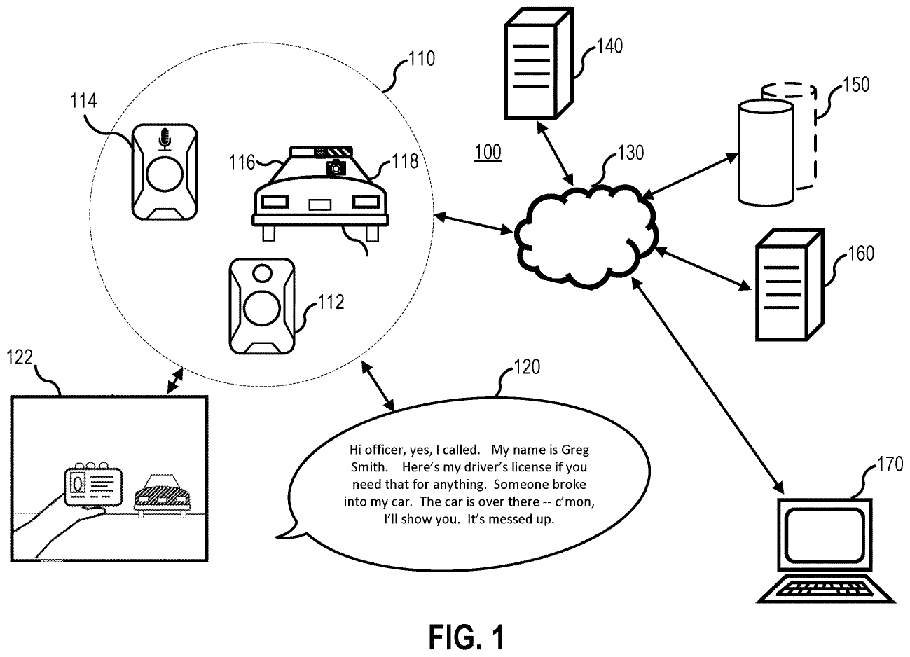

In embodiments, a system for automatically generating a report using event data may be provided. In some embodiments, the event data may comprise audio data. For example, and with brief reference to FIG. 1, system 100 for automatically generating a report according to various aspects of the present disclosure is provided. As illustrated in FIG. 1, an event at a location has occurred. The event is an event for which a structured report is generated. Information regarding the event may be provided via a system 100. For example, information regarding the event may be captured via a system 100. In embodiments, system 100 may comprise at least one recording device 110. The at least one recording device 110 may capture incident or event information. The event information, as captured by recording device 110, may comprise unstructured data. Unstructured data for the event may be further transmitted by recording device 110 to at least one computing device 140 and/or at least one data store 150 via network 130. Unstructured data may alternately or additionally be transferred to at least one other computing device. For example, generative computing device 160 and/or client computing devices 170 may further process the unstructured data for the event to generate structured data included in a report. As an example, an event may include a burglary of vehicle to which at least one responder responds with at least one recording device 110. The recording device 110 may capture unstructured data including data indicative of offense information, a vehicle, and/or a person associated with the event.

In embodiments, a recording device may be configured to record event information about an event. Recording incident information captures at least some of the information about the event. Recording incident information further protects against loss of information, for example, by physical loss or by faulty human memory. The recording device may comprise a sensor by which event information is captured. The recording device may further generate event data in which the event information is indicated. The event data may comprise digital data. The event data captured by the recording device may enable the event information to be subsequently reviewed, including via the recording device itself and/or other computing devices.

In embodiments, event information may comprise audio and/or visual information of the incident captured by a recording device. A system may comprise one or more recording devices by which event information may be recorded. For example, recording device 110 of system 100 may comprise a wearable camera, a wearable microphone, and/or a vehicle recording device. Each recording device of the recording device 110 may comprise an audio sensor configured to capture audio information 120 associated with an event. For example, each of first recording device 112, second recording device 114 and third recording device 116 comprise a respective input audio transducer that may transform audio signals into representative electronic signals. In embodiments, certain recording devices may further comprise an image sensor configured to capture image information associated with the event. The image information may include video information. For example, first recording device 112 and third recording device 116 may further comprise a video sensor by which visual information 122 for an event may be captured. Each recording device 110 may generate event data in which the audio and/or visual information is represented. For example, the event data may comprise image data, audio data, and/or video data. The event data may be available for subsequent processing, including by the recording device that captured the event information represented in the event data and/or other devices of system 100. In embodiments, each recording device 110 may be physically located at a physical location of the incident to capture the information about the incident.

In embodiments, each recording device 110 may comprise a portable recording device configured to be located at a location of an event. For the example event represented in FIG. 1, first recording device 112 may comprise a wearable camera configured to capture event data. The wearable camera may be configured to be mounted on a user. The wearable camera may be configured to be mounted on a chest, shoulder, and/or head of a user.

In embodiments, a recording device may be associated with a user. For example, each recording device 110 may be associated with a first responder. The first responder may be a first law enforcement officer. Recording device 110 may capture a set of unstructured data comprising audio data. In some embodiments, the first set of unstructured data may also comprise video data or other sensor data, such as data from a position sensor and beacon data from a proximity sensor of the recording device 110. Recording device 110 may capture the set of unstructured data throughout a time of occurrence of the event, without or independent of any manual operation by the first responder, thereby allowing the first responder to focus on gathering information and activity at the location of the event.

In embodiments, a set of unstructured data captured by recording device 110 may capture event information corresponding to one or more of each of an offense information, one or more objects at the location of the event, and other person(s) associated with the event. An offense information captured in the set of unstructured data may include a location of the recording device 110 captured by a position sensor of the recording device 110. A second offense information captured in the set of unstructured data may include an offense type or code, also referred to herein as an incident type. In embodiments, the event information may be captured in audio data generated from audio information 120 received via a microphone of recording device 110. Alternately or additionally, event information may be recorded in image data and/or video data generated from visual information captured via an image sensor of recording device 110. In embodiments, unstructured data in a set captured by recording device 110 may further include proximity data indicative of one or more signals received from another recording device. For example, first recording device 112 may capture wireless, short-range signals from second recording device 114 also located at the location of the event. In embodiments, the proximity data may indicate a physical proximity of another recording device. For example, proximity data detected by first recording device 112 may identify a distance between first recording device 112 and second recording device 114 at a time the proximity data is detected.

In embodiments, a recording device may store event data in a computer-readable storage medium integrated with the recording device. The computer-readable storage medium may provide non-temporary storage of the event data. The computer-readable storage medium may retain the event data until an instruction to delete the event data is received via a user interface of the recording device and/or from a remote computing device. The computer-readable storage medium may enable the event data to be transmitted via a network for subsequent processing. For example, each recording device of recording device 110 may respectively comprise a computer-readable storage medium in which event data generated by the respective recording device of recording device 110 may be stored.

In embodiments, a recording device may be configured to wirelessly offload event data to a remote computing device. Wireless offload may comprise streaming the event data. Wireless offload may enable a copy of the event data to be processed prior to upload of original event data stored in a computer-readable storage medium of the recording device. In some embodiments, the copy of event data offloaded may comprise a subset of the event data. For example, the offloaded data may comprise a reduced resolution copy of video data. Alternately or additionally, the offloaded data may comprise only an audio portion of audiovisual event data generated by a recording device. The recording device may concurrently store new event data in the computer-readable storage medium and transmit the new event data to a remote computing device via a communication interface of the recording device. Wireless offload may be separate and/or performed in addition to transmission of an original set of event data. Wireless offload may enable processing of the event data to be initiated before the original set of event data is uploaded. Wireless offload may enable processing of the event data to be initiated before an event for which the event data is generated has concluded. Wireless offload may enable processing of the event data to be initiated before generation of original event data for an event has been terminated.

In embodiments, a set of unstructured data for an event may be generated by different types of recording devices. For example, first recording device 112 may comprise a wearable camera configured to capture event data. The event data captured by first recording device 112 may comprise audio data and video data for the event. Alternately or additionally, event data for an event may be captured by a second recording device 114 comprising a wearable microphone. The wearable microphone may be configured to be mounted on a user. For example, the wearable microphone may be configured to be mounted on a chest, shoulder, and/or head of a user. Second recording device 114 may comprise an audio transducer configured to capture audio information 120. Second recording device 114 may lack a sensor by which visual information 122 may be captured. The event data captured by second recording device 114 may comprise audio data but not video data for the event. Alternately or additionally, event data for an event may be captured by third recording device 116 comprising a vehicle-mounted recording device. third recording device 116 may be configured to be mounted to vehicle 118. For example, third recording device 116 may be physically coupled to a roof, dashboard, and/or other interior or exterior portion of vehicle 118. Third recording device 116 may comprise an audio transducer configured to capture audio information 120. Third recording device 116 may also include an image sensor by which visual information 122 may be captured. The event data captured by third recording device 116 may comprise audio data and video data for the event. Event data captured by a respective recording device 110 may be separate from other event data captured by each other recording device of recording device 110. For example, first recording device 112 may capture a first set of event data and second recording device 114 may capture a second set of event data. Each recording device of recording device 110 may be associated with a same or different user. Each recording device of recording device 110 may capture a set of unstructured data throughout a time of occurrence of the event without, or independent of, any manual operation by a user, thereby allowing the user to focus on gathering information and other activities at the event.

In embodiments, recording device 110 may be configured to transmit a set of unstructured data to remote computing device 140 and/or data store 150 for further processing. The set of unstructured data may be transmitted via a network. For example, recording device 110 may be communicatively coupled with remote computing device 140 and/or data store 150 via network 130.

In embodiments, a network may enable communication between computing devices. For example, network 130 may include a cloud, cloud computing system, or electronic communications system or method that incorporates hardware and/or software components. Communication amongst the devices and systems over a network may be accomplished through a suitable communication channel or channels. For example, a communication channel may be provided via or more of a telephone network, an extranet, an intranet, the internet, a wireless communication, local area network (LAN), wide area network (WAN), virtual private network (VPN), and/or the like. In embodiments, network 130 may comprise a combination of wired and/or wireless networks by which event data may be transmitted from recording device 110 to remote computing device 140 and/or data store 150.

Electronic communications between the systems and devices may be unsecure. A network may be unsecure. In other embodiments, and to provide secure communications, electronic communications disclosed herein may utilize data encryption. Encryption may be performed by way of techniques available in the art. For example, encryption may be performed in accordance with techniques comprising one or more of Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms.

In embodiments, a set of unstructured data may be transmitted prior to conclusion of an event. For example, first recording device 112 may transmit audio data representing audio information 120 via network 130 to remote computing device 140 prior to termination of recording of the audio data by first recording device 112. The set of unstructured data may be transmitted in an ongoing manner (e.g., streamed, live streamed, etc.) to enable processing by another device while the event is occurring. Such transmission may enable one or more portions of report to be available for review prior to conclusion of the event and/or immediately upon conclusion of the event, thereby decreasing a time required for a responder to complete a report for the event.

In embodiments, a remote computing device may be configured to process received data to generate secondary data. The secondary data may be generated based on the received data. The secondary data may provide information associated with the input data. The secondary data may provide additional information regarding the input data. For example, system 100 may comprise at least one remote computing device 140. Remote computing device 140 may be configured to receive input data comprising event data from recording device 110 and/or data store 150. Remote computing device 140 may be configured to perform one or more operations to generate secondary data in accordance with the event data received from 110.

In embodiments, a remote computing device may be configured to generate secondary data comprising transcript data. The transcript data may comprise text data. The text data may indicate one or more words detected in audio data from which the transcript data is generated. A subset of the audio data may be processed to detect each word in the transcript. For example, remote computing device 140 may be configured to perform transcription operations on audio data. The transcription operations, upon application to the audio data, may cause transcript data to be generated indicating one or more words detected in the audio data. In some embodiments, the transcript data may comprise a sequence of tokens, wherein each token in the series of tokens corresponds to a character, word, or phrase detected in the audio data. Each token of the series of tokens may comprise respective text data that indicates a character, word, or phrase detected in the audio data.

In embodiments, transcript data may further comprise one or more timestamps. A timestamp of the transcript data may be associated with a portion of text data of the transcript data. A timestamp may indicate a chronological location in audio data from which an associated word was generated. A timestamp may comprise a starting point in time in the audio data at which an audio signal from which the word was generated was captured. Alternately or additionally, a time stamp may indicate a period of time in the audio data comprising an audio signal from which a word was detected. For example, remote computing device 140 may be configured to receive event data comprising audio data from recording device 110 and transcribe the audio data to generate transcript data comprising a set of transcription data records in which each data record of the set comprises text data and at least one timestamp. Each transcription data record may comprise a token.

A data store comprises a computing device configured to store data for access by a processing circuit. A data store receives data. A data store retains (e.g., stores) data. A data store retrieves data. A data store provides data for use by a system, a processing circuit, and/or an engine. A data store may organize data for storage. A data store may organize data as a database for storage and/or retrieval. The operations of organizing data for storage in or retrieval from a database of a data store may be performed by a data store. A data store may include a repository for persistently storing and managing collections of data. A data store may store files that are not organized in a database. Data in a data store may be stored in a non-transitory computer-readable storage medium. A data store may be integrated with another system. For example, in some embodiments, data store 150 may be integrated with remote computing device 140. In other embodiments, a data store may be accessible via a network. For example, data store 150 may be accessible via network 130 as illustrated in FIG. 1.

Data store 150 may perform operations of a data store. A data store may be implemented using a computer-readable storage medium (e.g., memory). The storage medium may comprise a non-transitory computer-readable storage medium. A computing device and/or a processing circuit may access a data store locally (e.g., via a data bus), over a network, and/or as a cloud-based service. For example, data store 150 may be provided at a network location rather than integrated within remote computing device 140.

In embodiments, a data store may store various types of data. For example, a data store may store event data, secondary data, and/or reports. Portions of a report of the reports may comprise computer-generated data as further discussed herein. In embodiments, each set of event data may be captured by a single recording device. In embodiments, each set of event data may be associated with a single event. In embodiments, each set of secondary data may be related to a single, respective set of event data. In embodiments, a report may be associated with a single set of event data or, alternately, a plurality of sets of event data.

In some embodiments, a data store may store one or more sample reports. A sample report may comprise a predetermined report. The sample report may comprise a predetermined format. For example, the sample report may comprise text data associated with a predetermined perspective, syntax, vocabulary, tone, subset of information, verb tense, and/or order of information. A sample report may comprise a subset of information. The subset of information may comprise a subset of information filtered from event data. The predetermined perspective may comprise, for example, a first-person perspective. The verb tense may comprise, for example, past tense. The vocabulary may comprise, for example, one or more words associated with an offense. The report may comprise a marker, indicator, or other information identifying the report as a sample report. As further discussed herein, a sample report may provide a representative set of data that may be generated from event data. Using a sample report, one or more computing devices may be configured to generate a new report for newly captured event data as further discussed herein.

In some embodiments, a sample report may be associated with a representative event. The representative event may or may not have occurred. Event data associated with the representative event may not exist. Event data associated with the representative event may be precluded from existing due to an illustrative and/or non-existent nature of the event represented in the report. In other embodiments, a sample report may comprise a previously generated report associated with an event. The previously generated report may be selected as a sample report. In some embodiments, the previously generated report may be manually generated.

In embodiments, a sample report may be associated with an incident type. The incident type may comprise an incident type of a plurality of incident types. For example, the plurality of incident types may comprise at least one of an assault, battery, damage to property, traffic accident, and theft. The plurality of incident types may comprise two or more of a group comprising an assault, battery, damage to property, traffic accident, and theft. A sample report may be associated with a single incident type of the plurality of incident types. A sample report may be associated with less than all incident types of the plurality of incident types.

In embodiments, different sample reports may be associated with different incident types. For example, data store 150 may store a plurality of sample reports comprising a first sample report with a first incident type of a plurality of incident types and a second sample report with a second incident type of the plurality of incident types. The first sample report may be different from the second sample report and the first incident type may be different from the second incident type.

In embodiments, an incident type may comprise a unique identifier. The unique identifier may comprise a unique alphanumeric identifier. The unique identifier may comprise an offense code identifying an activity that occurred during an event. The offense code may comprise a unique offense code. In embodiments, a report may comprise an incident type identified by the unique identifier. A sample report may include a unique identifier that identifies an incident type of the sample report. In embodiments, event data may comprise an incident type. For example, a set of event data generated by recording device 110 may comprise metadata indicating an incident type associated with the set of event data. The incident type of the set of event data may identify an incident captured or otherwise represented in the set of event data.

In embodiments, a report may be indexed in accordance with an incident type. One or more reports of a plurality of reports may be identified in accordance with a provided incident type. The incident type of a report may provide an index by which the report may be identified responsive to a search of a plurality of reports based on a provided incident type. Returning the report responsive to a search may comprise providing at least one sample report comprising an incident type that matches a provided incident type. In embodiments, indexing a report by an incident type may enable a report with a matching incident type to be selected among a plurality of sample reports associated with a plurality of respective, different incident types.

In embodiments, a plurality of sample reports may be associated with an entity. The entity may comprise a common entity associated with each recording device of a plurality of recording devices by which event data may be captured. For example, an entity may comprise a law enforcement agency. Data store 150 may store a plurality of sample reports associated with a same entity.

In embodiments, a plurality of entities may be associated with a respective plurality of sample reports. For example, a first entity of the plurality of entities may be associated with a first plurality of sample reports and a second entity of the plurality of entities may be associated with a second plurality of sample reports. The first plurality of sample reports may be different from the second plurality of sample reports. In embodiments, the first plurality of sample reports may be provided, generated, and/or selected via a computing device associated with the first entity. Each respective plurality of sample reports may be inaccessible to an entity with which it is not associated. For example, the first plurality of sample reports may not be accessible to the second entity. In accordance with the different pluralities of sample reports for different entities, a specific plurality of sample reports may be selected for use to generate a report for a corresponding entity. The specific plurality of sample reports may be selected in accordance with a same entity with which a recording device is associated. For example, a first recording device may be associated with a first entity and a second recording device may be associated with the second entity. In embodiments according to various aspects of the present disclosure, generating a report based on event data captured by the first recording device may comprise identifying a first plurality of sample reports associated with the first entity. The first plurality of sample reports may be selected instead of, for example, the second plurality of sample reports associated with the second entity. In embodiments, data store 150 may store respective pluralities of sample reports for different entities. In other embodiments, data store 150 may comprise separate data stores in which a respective plurality of sample reports is stored for each of a respective entity of a plurality of entities.

In embodiments, automatically generating a report may comprise using generative artificial information to generate information. For example, system 100 may comprise generative computing device 160. Generative computing device 160 may be configured to generate one or more portions of a report. Prompts may be received via a network interface of generative computing device 160. Responsive to the prompts, generative computing device 160 may generate report information. The report information may comprise text information. For example, generative computing device 160 may be configured to generate a narrative portion of a report in accordance with a received prompt. The report information may be further provided to one or more of remote computing device 140 or data store 150 for inclusion in a report.

In embodiments, generative computing device 160 may be configured to receive prompt information comprising transcript information. For example, generative computing device 160 may receive a prompt comprising transcript data associated with audio data captured by a microphone of recording device 110. Generative computing device 160 may generate report information associated with the transcript data. For example, generative computing device 160 may be pre-trained to receive transcript data and, in accordance with the transcript data, generate report information corresponding to event information represented in the audio data. Generative computing device 160 may be configured to summarize the event information represented in the event data. For example, generative computing device 160 may be configured to filter, reorder, collect, combine, or extract event information represented in audio data received by generative computing device 160. For example, transcript information may include information indicating weather that occurred while event data was captured. In accordance with one or more operations of generative computing device 160, information indicating the weather may be excluded from report information output by generative computing device 160. As another example, prompt information may indicate a person's first name separate from the person's last name. In accordance with one or more operations of generative computing device 160, the person's first name and last name may be provided adjacent to each other in the report information.

In embodiments, the report information generated by generative computing device 160 may comprise additional information relative to information in prompt information received by generative computing device 160. For example, the report information may comprise additional information indicating one or more words that are related to, but not included in prompt information. For example, transcript data may comprise a single instance of a person's name, while in accordance with one or more operations of generative computing device 160, report information may comprise multiple instances of the person's name to describe an event. The additional information may be provided by generative computing device 160 in accordance with a manner in which generative computing device 160 has been trained to generate report information. In some embodiments, the additional data may comprise secondary data generated by system 100 in accordance with automatically generating a report.

In embodiments, and in accordance with one or more operations of generative computing device 160, report information may comprise a subset of prompt information. The subset may comprise descriptive information associated with an event. For example, prompt information may comprise a person's name. In accordance with one or more operations of generative computing device 160, report information generated by generative computing device 160 may comprise the person's name received in the prompt information. However, as noted above, other information from the prompt information may be excluded.

In embodiments, and in accordance with one or more operations of generative computing device 160, report information may comprise a plurality of source indicators. Each source indicator may be associated with a respective portion of the report information. Each source indicator may indicate the respective portion of the report information. Each source indicator may further identify a portion of prompt information from which the respective portion of the report information was generated. For example, prompt information received by generative computing device 160 may comprise transcript information generated from audio data captured over a period of time. Report information generated from the transcript information by generative computing device 160 may comprise a plurality of source indicators. Each source indicator may logically identify a corresponding portion of the transcript information based on which the corresponding portion of the report information may be generated. In embodiments, a source indicator may comprise a timestamp or other logical address that uniquely identifies a portion of prompt information. The portion of prompt information may comprise a single location or, alternately, a range of locations within the prompt information. In some embodiments, a source identifier may particularly refer to a location within transcript information received in a prompt by generative computing device 160.

In embodiments, prompt information may further comprise a sample report. Generative computing device 160 may be configured to generate report information in accordance with the sample report. For example, the sample report may indicate reference information indicating a predetermined perspective of writing, syntax, vocabulary, tone, subset of information, verb tense, and/or order of information. In accordance with a manner in which generative computing device 160 has been trained, generative computing device 160 may identify the reference information from the sample report. Generative computing device 160 may further generate report information in accordance with the reference information. For example, the report information may comprise text data that describes an event indicated in transcript information included in a prompt in a manner that reflects a format indicated in a sample report also included in the prompt.

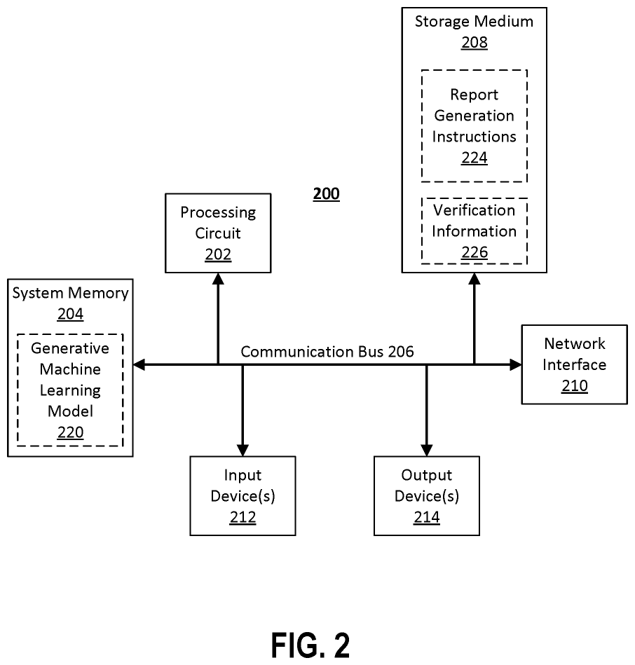

In embodiments, a system for automatically generating a report may comprise a client computing device configured to review the report. For example, system 100 may comprise client computing device 170. Client computing device 170 be communicatively coupled to remote computing device 140 and/or data store 150. Client computing device 170 be communicatively coupled to remote computing device 140 and/or data store 150 via network 130. Client computing device 170 be communicatively coupled to receive a report and/or event data from remote computing device 140 and/or data store 150. Client computing device 170 may enable a user to review event data captured for an event. Client computing device 170 may enable a user to review a report. Client computing device 170 may enable a user to revise an automatically generated report. In some embodiments, client computing device 170 may enable event data and an automatically generated report to be reviewed at a same time. In accordance with the concurrent review of event data and a report generated in accordance with the event data, accuracy of automatically generated report may be verified. Such an arrangement may alternately or additionally enable additional information for a report to be identified. In some embodiments, the additional information may be manually added to an automatically generated report. Alternately or additionally, such an arrangement may enable a user to delete or otherwise edit computer-generated report information. In embodiments, client computing device 170 may download a copy of a report from data store 150, along with associated recorded data from data store 150. The data store 150 and client computing device 170 may include various components, including those shown in FIG. 2 and/or further discussed below. In embodiments, client computing device 170 may comprise one more of a smartphone, desktop computing device, tablet computing device, or a mobile data terminal mounted within a vehicle. In embodiments, client computing device 170 may comprise a plurality of client computing devices.

In various embodiments, and with reference to FIG. 2, an exemplary computer-based system 200 is disclosed. Computer-based system 200 may be appropriate for use in accordance with embodiments of the present disclosure. The accompanying description of computer-based system 200 may be applicable to servers, personal computers, mobile phones, smart phones, tablet computers, embedded computing devices, field devices, and other devices that may be used in accordance with embodiments of the present disclosure. For example, computer-based system 200 may correspond to a recording device and/or a computing device based at least in part on the configuration of computer-based system 200. Computer-based system 200 may be configured to perform one or more operations of recording device 110, remote computing device 140, data store 150, generative computing device 160, and/or client computing device 170 with brief reference to FIG. 1.

A processing circuit may control, in whole or in part, operations of a computing system. A processing circuit may control the operations performed by a computing or recording device. A processing circuit may cause event data to be recorded by a recording device in which the processing circuit is provided. A processing circuit may cause a report to be generated. A processing circuit may cause event data and/or report information to be transmitted and/or received by computing device in which the processing ciurcuit is provided. A processing circuit may execute one or more modules on audio data to generate additional data. The additional data may be separate from the audio data. The additional data may comprise transcript data. The transcript data may include one or more values usable by a device to perform a subsequent task. The additional data may be generated based on audible information in audio data processed by the processing circuit. The additional data may not exist until audio data is processed by a processing circuit. The additional data may be output from the processing circuit and provided to one or more other components or devices.

A processing circuit may provide and/or receive electrical signals whether digital and/or analog in form. A processing circuit may provide and/or receive digital data (e.g., information) via a bus using a protocol. For example, processing circuit 202 may comprise communication bus 206 by which digital data may be exchanged with one or more other components of system 200. A processing circuit may receive data, manipulate data, and provide the manipulated data. A processing circuit may store data and retrieve stored data. Data received, stored, and/or manipulated by a processing circuit may be used to perform a function.

In embodiments, a processing circuit may include circuitry and/or electrical/electronic subsystem for performing a function. A processing circuit may execute one or more stored programs. A processing circuit may execute one or more stored modules. A processing circuit may include a digital signal processor, a microcontroller, a microprocessor, an application specific integrated circuit, a programmable logic device, logic circuitry, state machines, MEMS devices, signal conditioning circuitry, memory, data busses, and/or address busses. A processing circuit may include conventional passive electronic devices (e.g., resistors, capacitors, inductors) and/or active electronic devices (e.g., op amps, comparators, analog-to-digital converters, digital-to-analog converters, programmable logic). A processing circuit may include output ports, input ports, timers, embedded memory, and/or arithmetic units.

A processing circuit may control the operation and/or function of other circuits and/or components of a system. A processing circuit may receive data from other circuits and/or components of a system. A processing circuit may receive status information regarding the operation of other components of a system. A processing circuit may provide commands (e.g., instructions, signals) to one or more other components responsive to data and/or status information. A command may instruct a component to start operation, continue operation, alter operation, suspend operation, and/or cease operation. Commands and/or status may be communicated between a processing circuit and other circuits and/or components via a type of bus. In embodiments, processing circuit 202 may be configured to cause system 200 to perform one or more operations via control of one or more other components of system 200. Commands, status, and/or data may be transferred between processing circuit 202 via communication bus 206. While illustrated as a common component in FIG. 2, communication bus 206 may comprise one or more communication paths for system 200. The one or more communication paths may comprise shared or direct communication paths between two or more components of system 200.

Computer-based system 200 may include a processing circuit 202 and a system memory 204 connected by a communication bus 206. Depending on the exact configuration and type of computer-based system, system memory 204 may be volatile or nonvolatile memory, such as read only memory (“ROM”), random access memory (“RAM”), EEPROM, flash memory, or other memory technology. Those of ordinary skill in the art will recognize that system memory 204 typically stores data and/or instructions and/or program modules that are immediately accessible to and/or currently being operated on by processing circuit 202. The data and/or instructions and/or program modules may be retrieved from other storage mediums accessible by system 200. For example, the data and/or program modules may be retrieved from storage medium 208 for storage on memory 204. In this regard, processing circuit 202 may serve as a computational center of computer-based system 200 by supporting the execution of instructions. Processing circuit 202 may comprise one or more processing units. System memory 204 may comprise one or more memory units.

Computer-based system 200 may include a network interface 210 comprising one or more components for communicating with other devices and systems over a network. Embodiments of the present disclosure may access services that utilize network interface 210 to perform communications using network protocols. Network interface 210 may comprise a communications unit, as discussed further herein.

Computer-based system 200 may also include a storage medium 208. However, services may be accessed using a computer-based system that does not include a component or components for persisting data to a local storage medium. Therefore, storage medium 208 depicted in FIG. 2 may be optional. Storage medium 208 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. Storage medium 208 may include one or more memory units, as discussed further herein. In embodiments in which system 200 is configured to perform one or more operations of a generative computing device, at least one of system memory 204 and/or storage medium 208 may store generative machine learning model 220 as further discussed herein.

As used herein, the term “computer-readable storage medium” includes volatile and nonvolatile, as well as removable and nonremovable media implemented in a method or technology capable of storing information, such as computer-readable instructions, data structures, program modules, or other data. The term “computer-readable storage medium” further comprises non-transitory media. In this regard, system memory 204 and storage medium 208 depicted in FIG. 2 are examples of non-transitory computer-readable storage media. In embodiments, computer-readable instructions stored in a computer-readable storage medium may be executed by processing circuit 202. When executed by the processing circuit, the instructions may cause the processing circuit and/or the computer-based system to perform operations. The operations may include one or more operations of one or more methods disclosed herein.

In any of the described examples, data can be captured by one or more input devices 212 for transmission, storage, and/or future processing. The processing may include encoding data streams, which can be subsequently decoded for presentation by output devices. Media data can be captured by multimedia input devices of input devices 212 and stored by saving media data streams as files on a computer-readable storage medium (e.g., in memory or persistent storage on a client device, server, administrator device, or some other device). For example, media data may be stored in storage medium 208. Input devices 212 can be separate from and communicatively coupled to computer-based system 200 (e.g., a client device), or can be integral components of computer-based system 200. In some embodiments, multiple input devices may be combined into a single, multifunction input device (e.g., a video camera with an integrated microphone). In embodiments, one or more of storage medium 208 and processing circuit 202 may implement one or more functions of a recording device, remote computing device, generative computing device, data store, or client computing device. In embodiments in which system 200 is configured to perform one or more operations of a recording device, input devices 212 may comprise at least one microphone. In other embodiments, including when system 200 is configured to perform one or more operations of a remote computing device, data store, or generative computing device, system 200 may lack input devices 212.

In embodiments, computer-based system 200 may also include one or more output devices 214 such as a display, speakers, and/or any other output device described herein. The output devices 214 may include video output devices such as a display or touchscreen. The output devices also may include audio output devices such as external speakers or earphones. The output devices can be separate from and communicatively coupled to computer-based system 200 or can be integrated components of computer-based system 200. Input functionality and output functionality may be integrated into the same input/output device (e.g., a touchscreen). A suitable input device, output device, or combined input/output device may be used with described systems. In embodiments in which system 200 is configured to perform one or more operations of a client computing device, output devices 214 may comprise at least one output audio transducer and at least one display. In other embodiments, including when system 200 is configured to perform one or more operations of a remote computing device, data store, or generative computing device, system 200 may lack output devices 214.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a composite device (e.g., a device having a plurality of different forms of output), and/or any other output device.

In various embodiments, one or more elements of computer-based system 200 may correspond (e.g., include, implement, perform one or more functions of, etc.) to one or more elements discussed by FIGS. 1 and 3-6. For example, processing circuit 202 may be configured as a processor or processing circuit. Network interface 210 may be configured as a communication circuit. Other correspondence between other elements disclosed herein may also exist, as will be appreciated by one of ordinary skill in the art.

A communication circuit transmits and/or receives information (e.g., data). A communication circuit may transmit and/or receive (e.g., communicate) information via a wireless and/or wireless communication link. A communication circuit may communicate using wireless (e.g., radio, light, sound, vibrations) and/or wired (e.g., electrical, optical) mediums. A communication circuit may communicate using any wireless (e.g., BLUETOOTH, ZIGBEE, WAP, WiFi, NFC, IrDA, LTE, BLE, EDGE, EV-DO) and/or wired (e.g., USB, RS-232, Firewire, Ethernet) communication protocol. A communication circuit operable or configured to transmit and/or receive information over a wireless medium and/or via a wireless communication protocol may include a wireless communication circuit. In embodiments, network interface 210 may comprise a communication circuit.

A communication circuit may transmit and/or receive (e.g., communicate) data via a wireless link. A communication circuit may perform short-range wireless communication and/or long-range wireless communication. Short-range wireless communication may have a transmission range of approximately 20 cm-100 meters. Communication protocols for short-range wireless communication may include BLUETOOTH, ZIGBEE, NFC, IrDA and WiFi. Long-range wireless communication may have a transmission ranges up to 15 kilometers. Communication protocols for long-range wireless communication may include GSM, GPRS, 3G, LTE, and 5G. A communication circuit may communicate via a base station using long-range wireless communication. In embodiments, network interface 210 may be configured to perform one or more operations of a communication circuit.

In embodiments, computer-based system 200 may perform one or more operation of generative computing device 160 for generating report information. For example, system 200 may comprise a processing circuit 202 and at least one of memory 204 and/or storage medium 208 configured to perform one or more operations for generating report information. Processing circuit 202, memory 204, and storage medium 208 may be similar to one or more other processors, memories, and/or storage mediums disclosed herein. One or more of memory 204 and/or storage medium 208 may store instructions that, when executed by processing circuit 202, cause a generative computing device implemented via system 200 to receive a prompt from a remote computing device and/or server computing device to enable report to be generated. The instructions, when executed by processing circuit 202 may further enable a generated report to be transmitted to a remote computing device and/or server computing device from which a corresponding prompt was received.

In embodiments, instructions stored in memory 204 and/or storage medium 208 may comprise generative machine learning model 220. Generative machine learning model 220 may comprise a large language model (LLM). The LLM may comprise an artificial neural network trained to generate output text data responsive to input text data applied to the LLM. The output text data may comprise text data engineered to comprise human-readable text information. The output text data may comprise words, as well as syntax, associated with human language. In embodiments, storage medium 208 may alternately or additionally store generative machine learning model 220 executable by processing circuit 202 according to various aspects of the present disclosure.

In embodiments, generative machine learning model 220 may comprise instructions that, when executed by processing circuit 202, may configure system 200 to generate a report. Generative machine learning model 220 may comprise a LLM trained to receive a prompt and, responsive to the prompt, generate a response. The prompt may comprise text data indicating one or more features that should be included in the dialog response. In some embodiments, the prompt may comprise transcript data indicating audio data captured by a recording device. Generative machine learning model 220 may be applied to the prompt to generate a report. The report may be machine-generated in accordance with a manner in which generative machine learning model 220 was trained. For example, one or more words and/or a syntax of the generated dialog response may be at least partially determined in accordance with a manner in which the generative machine learning model 220 was trained. At least part of the report may be different from the prompt. For example, and relative to the prompt., a generated report may comprise a different syntax and/or different word(s) relative to a transcript or other information included in a prompt. In some embodiments, the generated report may comprise additional information that generative machine learning model 220, in accordance with its training, may determine to be related to the prompt. In accordance with various aspects of the present disclosure, generative machine learning model 220 may enable the report to be automatically generated, in addition to or as an alternative to a report that may be manually generated using one or more other components of a computer-based system. In accordance with various aspects of the present disclosure, generative machine learning model 220 may enable a portion of a report to be automatically generated, in addition to or as an alternative to other portions of the report that may be manually generated using one or more other components of a same or different computer-based system.

In embodiments, instructions stored on a memory and/or computer readable storage medium may comprise report generating instructions. The instructions may be predetermined. The instructions may be generated prior to capture of audio data by a recording device. The instructions may comprise a set of information associated with generating a report. In some embodiments, the set of information may enable a general-purpose machine learning model to generate text information specifically for use in a report associated with a law enforcement or other security-related event. For example, and with brief reference to FIG. 2, memory 204 and/or storage medium 208 may store report generating instructions 224. The instructions 224 may be stored in a location accessible to processor 202 for inclusion in a prompt generated by processing circuit 202 according to various aspects of the present disclosure.

In embodiments, report-generating instructions may be at least partially static. For example, a same set of stored instructions may be retrieved for inclusion in a prompt for each report generated by a computing system. For example, a same set of instructions may be included in a first prompt used to generate a first report associated with a first event, as well as a second prompt used to generate a second report associated with a second event. The set of instructions may be included in each prompt independent of a type of event. For example, the first event may be associated with a burglary, while a second event may be associated with an assault; respective prompts for each of these events may comprise at least partially common set of report generating instructions.

In embodiments, the report-generating instructions may be automatically retrieved to generate a report. The report-generating instructions may be provided for inclusion in a prompt by default. For example, upon receipt of an instruction to generate a report for audio data, instructions 224 may automatically be retrieved by processing circuit 202. Processing circuit 202 may further automatically include instructions 224 in a prompt used to generate a report, along with a transcript of the audio data. In some embodiments, the report-generating instructions may automatically be retrieved upon receipt by system 200 of audio data.

In embodiments, instructions stored on a memory and/or computer readable storage medium may comprise verification information. The verification information may comprise a plurality of sets of text data. Each set of the sets of text data may comprise text data associated with one or more predetermined words. For example, a set of text data may comprise text data that corresponds to a sentence. Each set of text data may be predetermined. For example, verification information 226 may comprise text data that is unassociated with event data. Verification information 226 may be generated prior to event data being captured by recording device 110 with brief reference to FIG. 1. Verification information 226 may be generated independent of event data captured by at least one recording device. Verification information 226 may be further independent of prompt information on which a report may be automatically generated. In accordance with a distinction between verification information 226 and a draft report generated by a generative computing device, a likelihood that a set of text data of verification information 226 in a provided report may be identified. In accordance with a distinction between verification information 226 and a draft report generated by a generative computing device, a distinction may be preserved between verification information 226 and report information automatically generated for a report. In embodiments, a set of text data of the plurality of sets of text data may be selected for inclusion in an automatically generated report. Generating the report may comprise adding verification information to an automatically generated report prior to the report being provided to a client computing device.

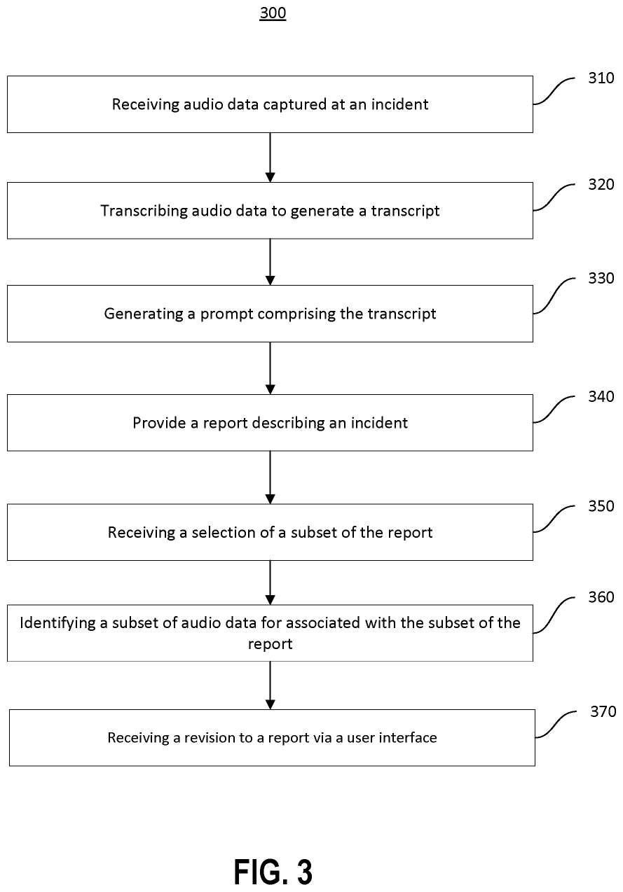

In embodiments, a method for automatically generating a report may be provided. For example, and with brief reference to FIG. 3, method 300 for automatically generating a report is provided. Method 300 may be performed by at least one computing system. For example, at least one computing device may comprise a processing circuit and at least one non-transitory computer-readable storage medium storing instructions that, when executed by the processing circuit, cause the at least one computing device to perform one or more operations disclosed herein. The at least computing device may comprise a computer-based system. For example, computer-based system 200 may be configured to perform one or more operations of method 300 with brief reference to FIG. 2. In embodiments, the at least one computing system may comprise one or more computing devices of a system for capturing event data associated with an incident. For example, and with brief reference to FIG. 1, remote computing device 140 may be configured to perform one or more operations of method 300. In alternate embodiments, alternate or additional computing devices may be configured to perform one or more operations of method 300. For example, and in some embodiments, one or more operations of method 300 may be performed by recording device 110 and/or client computing device 170. In embodiments, method 300 may comprise operations comprising receiving 310 audio data captured at an incident, transcribing 320 audio data to generate a transcript, generating 330 a prompt comprising the transcript, providing 340 a report describing an incident, receiving 350 a selection of a subset of the report, identifying 360 a subset of audio data associated with the subset of the report, and/or receiving 370 a revision to a report via a user interface.

In embodiments, audio data captured at an incident may be provided for automatic generation of a report. The audio data may comprise a set of information. The audio data may describe the incident. The audio data may indicate one or more occurrences and/or objects associated with the event. The audio data may be captured at a location of an event. The audio data may be captured by at least one recording device. For example, and with brief reference to FIG. 1, audio data may be captured by at least one recording device 110 at a location of an incident. The audio data may comprise audio information 120. Recording device 110 may be configured to provide event data comprising the audio data to one or more of remote computing device 140 and/or data store 150. Remote computing device 140 may be configured to receive the audio data captured by recording device 110. Data store 150 may be configured to receive the audio data captured by recording device 110. In some embodiments, client computing device 170 may be configured to receive the audio data captured by recording device 110. The audio data may be received via network. For example, the audio data may be received by a computing device via network 130. Receiving 310 may comprise remote computing device 140, data store 150, and/or client computing device 170 receiving audio data captured by recording device 110.

In some embodiments, receiving 310 may comprise receiving the audio data prior to completion of recording of the audio data. Receiving the audio data may comprise streaming the audio data while the audio data continues to be captured by a recording device. Alternately or additionally, receiving the audio data may comprise receiving a first portion of an audio file comprising the audio data while a second portion of the audio file comprising the audio data continues to be captured by a recording device from which the first portion of the audio file is offloaded.

In embodiments, audio data may be transcribed to generate transcript information for subsequent generation of a report. For example, method 300 may comprise transcribing 320 audio data to generate a transcript. The audio data may comprise audio data received upon receiving 310. Transcribing 320 may be performed after receiving 310 and/or responsive to receiving 310. For example, a computing device may be configured to automatically transcribe audio data upon receipt of the audio data by the computing device. Transcribing 320 may comprise generating the transcript based on the audio data. The transcript may comprise transcript information. The transcript may comprise word information. The transcript may comprise a sequence of tokens. The sequence of tokens may indicate text information. For example, the transcript may indicate one or more words detected in the audio data. The one or more words may be associated with speech or spoken audio signals captured in the audio data. The one or more words may comprise, for example, the one or more words captured in audio information 120 with brief reference to FIG. 1. The transcript may comprise order information. For example, the transcript may indicate a sequence in which one or more words were captured in the audio data. The transcript may comprise grouping information. For example, the transcript may comprise punctuation that indicates sets of words detected in the audio data. The sets of words may comprise clauses or sentences detected in the audio data. The transcript may comprise source information. For example, the transcript may include labels indicating which person of a plurality of persons is detected to have spoken a corresponding word or words of the transcript. In some embodiments, the labels may distinguish between different persons detected in audio data. However, the labels may lack unique identifying information regarding a given source. For example, the labels may indicate whether a first person or second person is detected to have spoken a given word as captured in the audio data. However, the sources may be labeled as “Person 1” and “Person 2” in the transcript, rather than comprising, for example, any unique or personal identifying information. The transcript may further comprise timing information. For example, the transcript may comprise timing information indicating a chronological point in time in the audio data at which a corresponding word was detected. In some embodiments, the timing information may comprise one or more timestamps. The one or more timestamps may be provided for each of a plurality of words in the transcript. In some embodiments, each word detected in a transcript may be associated with at least one respective timestamp.

In embodiments, transcribing 320 may comprise generating transcript data associated with the transcript. The transcript data may comprise text data. The text data may indicate portions of the transcript. For example, transcribing 320 may comprise generating text data indicating words detected from audio data and timestamps associated with the words. In embodiments, the transcript data may be portable. The portable transcript data may be transmitted to another computing device for further processing. For example, transcribing 320 may comprise generating transcript data that may be further included in a prompt.

In embodiments, transcribing 320 may comprise obtaining the transcript from another computing device. For example, a computing device may be configured to provide audio data to a second computing device configured to perform one or more operations to transcribe the audio data. Responsive to providing the audio data to the second computing device, the computing device may receive transcript data generated by the second computing device, wherein the transcript data comprises a transcript. The transcript may correspond to audible information captured in the audio data that is further transformed into transcript information represented in the transcript data. In other embodiments, a same computing device that receives audio data upon receiving 310 may further generate a transcript from the audio data upon transcribing 320.

In embodiments, a prompt for a generative machine learning model may be generated. The prompt may comprise information indicating a request for a generative computing device on which the generative machine learning model is implemented. The prompt may indicate an output requested from the generative machine learning model. The prompt may indicate content and/or a format of the output requested from the generative machine learning model. For example, method 300 may comprise generating 330 a prompt comprising the transcript. The prompt may request that the generative machine learning model be applied to the transcript to generate a report. The prompt may comprise instructions for generating the report based on the transcript. The instructions may comprise one or more of format-related instructions, requirements, and/or restrictions associated with a report to be generated by the generative machine learning model. The prompt may be generated for input to a generative computing device on which a generative machine learning model is executed. For example, remote computing device 140 may generate a prompt for transmission to generative computing device 160 on which at least one generative machine learning model is executed.

In embodiments, generating 330 may comprise providing the prompt as input to a generative machine learning model. For example, generative computing device 160 may be configured to apply a generative machine learning model to a prompt received by generative computing device 160. Generating 330 may comprise transmitting, by another computing device, the prompt to generative computing device 160. Responsive to receiving the prompt, generative computing device 160 may be configured to apply the prompt as input upon which the generative machine learning model subsequently generates a report. In embodiments, the other computing device may comprise recording device 110, remote computing device 140, and/or client computing device 170. In some embodiments, the other computing device may be configured to transmit the prompt via a network to the generative computing device.

In embodiments, generating 330 may comprise providing predetermined instructions with the transcript. The predetermined instructions may be selected to cause a generative machine learning model to provide a report relative to a transcript included with the prompt. The predetermined instructions may indicate a transformation to be applied to the transcript by the generative computing device. The predetermined instructions may comprise one or more rules that are applied by the generative computing device to generate the report based on the transcript. A rule of the one or more rules may indicate a transformation to be applied by the generative computing device to generate the report from the transcript. For example, the predetermined instructions may indicate one or more of information from the transcript to be included in the report, information from the transcript to be excluded from the report, or an order in which information from the transcript is provided in the report. Alternately or additionally, the predetermined instructions may comprise a language in which the report should be generated. The language may be the same, different, or partially the same as a language in which the transcript is provided. Alternately or additionally, the predetermined instructions may comprise a perspective in which the report should be generated. The perspective in which the report is generated may be different from the perspective(s) reflected in the transcript. Alternately or additionally, the predetermined instructions may indicate a format of the report to be generated from the transcript. For example, the format may include one or more of paragraphs, lists, capitalization, passive voice, active voice, or section headings to be used or not used in the report. As with other transformations indicated by the predetermined instructions, such a format may differ from a format in which information is represented in the transcript. The predetermined instructions may be at least partially common for each prompt of a plurality of prompts generated for a plurality of respective different transcripts. For example, the instructions may indicate that output for use in a report in a law enforcement context should be generated. One or more rules in the predetermined instructions may be applied for each report generated by the generative computing device. The one or more rules may be applied independent of a transcript for which a report is generated and/or an incident type associated with the report. In embodiments, the predetermined instructions may be stored in a storage medium of at least one computing device. Upon generating 330, the predetermined instructions may be retrieved by a processing circuit of the computing device for inclusion in a prompt generated by the computing device. Generating 330 may comprise adding predetermined instructions to prompt information to generate the prompt.

In embodiments, generating 330 may comprise including the transcript in the prompt. At least a portion of the prompt may comprise the transcript. The transcript may comprise the transcript generated upon transcribing 320. Generating 330 may comprise including transcript information of the transcript in the prompt information of the prompt. For example, generating 330 may comprise generating a prompt comprising word information, source information, and timing information of a transcript. In accordance with the transcript information, the generative machine learning model may be configured to generate a report corresponding to an incident represented in the transcript.

In embodiments, generating 330 may comprise including call for service information in the prompt. The call for service information may identify an incident. For example, call for service information may comprise one or more of a date of an incident, a location of an incident, a time of an incident, or a name of a person assigned to the incident. The person may be an emergency responder assigned to the incident. The person may be a person to which a recording device is assigned, wherein the recording decide captures the event data upon which a report is subsequently generated. Generating 330 may comprise obtaining the call for service information from a computing device. For example, the call for service information may be obtained from a dispatch computing device. Alternately or additionally, the call for service information may be obtained from one or more of an evidence management computing device and/or a records management computing device. At least a portion of the prompt may comprise the call for service information. Generating 330 may comprise requesting the call for service information. In response to the requesting, generating 330 may comprise receiving the call for service information prior to transmission of the prompt to a generative computing device. In accordance with the call for service information, a generative machine learning model applied to the prompt by a generative computing device may accurately indicate a time and/or person involved with responding to an incident in a subsequently generated report.

In embodiments, a report may be provided. The report may be automatically generated. The report may be computer-generated. The report may comprise a portion of the report. For example, providing the report may comprise providing a narrative portion of a report. The report may be provided responsive to providing a prompt to a generative computing device. The report may be automatically provided in response to a prompt being provided as input to a generative machine learning model. The report may describe an incident indicated in the prompt. The report may describe an incident indicated in transcript information included in the prompt. For example, method 300 may comprise providing 340 a report describing an incident. The incident may comprise a same incident associated with a prompt generated upon generating 330. The incident may not be predetermined or otherwise previously known to (e.g., logically indicated or detected by) a generative computing device by which the report is generated. However, and in accordance with a prompt, a report describing the incident may be provided.

In embodiments, providing 340 may comprise executing a generative machine learning model. For example, providing 340 may comprise applying generative machine learning model 220 to prompt information in a prompt. The generative machine learning model may be executed on a same or different computing device at which a prompt was generated. For example, remote computing device 140 may execute a generative machine learning model in some embodiments, while in other embodiments, generative computing device 160, which is in communication with remote computing device 140 via network 130, may execute a generative machine learning model. Executing the generative machine learning model may comprise parsing a prompt to provide prompt information from the prompt as input to the generative machine learning model. Executing the generative machine learning model may comprise applying the generative machine learning model to prompt information of a prompt. In some embodiments, the generative machine learning model may not be accessible for modification from another computing device. For example, remote computing device may be unable to modify a generative machine learning model executed by generative computing device 160. Such lack of access may limit an extent to which improvements to the generative machine learning model, as well as outputs of the generative machine learning model, may be made via remote computing device 140. However, and in accordance with various aspects of the present disclosure, technical improvements to the output of the generative machine learning model may be provided in a computer-based system, independent of whether an employed generative machine learning model may itself be directed tuned or otherwise modified.

In embodiments, providing 340 may comprise generating the report. The report may be automatically computer-generated in accordance with applying a generative machine learning model to a prompt. The generative machine learning model may be configured to generate the report. The report may comprise text data describing an incident. The generative machine learning model may be configured to, upon receipt of a prompt comprising a transcript of audio data associated with the event, generate the report describing the incident. For example, generative computing device 160 may be configured to apply a generative machine learning model to generate a report comprising text data associated with an incident. In some embodiments, generating the report may comprise generating a narrative portion of the report.

In embodiments, providing 340 may comprise receiving the report. Receiving the report may comprise receiving the report from another computing device. The report may be received from the other computing device over a network. For example, remote computing device 140 may receive a report from generative computing device 160. Alternately or additionally, client computing device 170 may receive a report from generative computing device 160.

In embodiments, providing 340 may comprise providing an output. The output may comprise a visual presentation of the report. Providing 340 may comprise providing an output comprising a report via a display of a computing device. For example, providing 340 may comprise providing a report via a display of client computing device 170. The output may be provided from another computing device. For example, remote computing device 140 may provide an output comprising the report to client computing device 170. Remote computing device 140 may provide the report in a format that enables display of text data of the report via a display device of client computing device 170.

In embodiments, providing 340 may comprise providing text information of the report. For example, providing 340 may comprise providing text data indicating a plurality of words of the report. The text information may be different from prompt information from which the report was generated. For example, the text information may comprise different words and/or words in a different order relative to words in prompt information of a prompt based on which the text information was generated. The different words may be selected upon generation of the report to summarize transcript information and/or more clearly convey the incident in a written form of the report.

In embodiments, providing 340 may comprise providing an indication of a portion of a transcript associated with text information of a report. The indication may provide a logical association between the portion of the transcript and the text information of the report. The text information of the report may be generated based on the portion of the transcript. For example, the indication may identify one or more words of the transcript from which one or more words of the report may be generated.

In embodiments, the indication may comprise timing information. The timing information may be associated with text information of the report. The timing information may be associated with respective portions of the report. For example, the timing information may comprise one or more timestamps. Each timestamp of the one or more timestamps may be associated with a respective portion of the report. For example, each word, clause, and/or sentence of text information of a report may be associated with a respective timestamp. Each timestamp may correspond to a portion of a transcript. Each timestamp may indicate a portion of the transcript from which the corresponding portion of the text information of the report was generated. For example, a transcript may indicate that one or more statements were detected during a period of time within audio data. The transcript may comprise one or more timestamps or other timing information indicating the period of time. Text information for a report may comprise a sentence generated based on the one or more statements in the transcript. Providing 340 may comprise providing the sentence in text information of the report. Providing 340 may further comprise providing timing information associated with the sentence, wherein the timing information comprises the timestamps or other timing information associated with the one or more statements indicated in the transcript.

In embodiments, providing 340 may be performed responsive to generating 330. providing 340 may be automatically performed after a prompt is generated. Providing 340 may be automatically performed in response to a report being received. The report may be automatically received responsive to a prompt generated upon generating 330 being provided to a generative computing device.

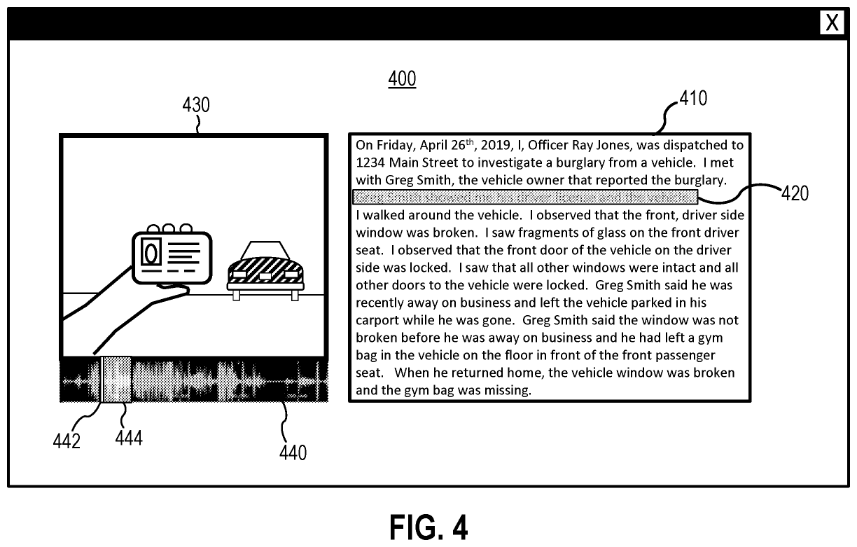

In embodiments, and with brief reference to FIG. 4, providing 340 may comprise providing an output via a user interface 400. User interface 400 may be provided via a display of a computing device. For example, user interface 400 may be provided via a display of client computing device 170 with brief reference to FIG. 1.

In embodiments, user interface 400 may comprise text display element 410. Text display element 410 they comprise a portion of user interface 400. Text display element 410 may comprise one or more of a window, a frame, or an input element of user interface 400. Text display element 410 may visually present the report for a user. For example, text display element 410 may display a narrative portion of a report generated by a generative computing device. Text data of the report may be visually presented via the text display element 410. Text display element 410 may visually output a plurality of words of the report. Text display element 410 may show word information of a report via a user interface device of a computing device.

In embodiments, user interface 400 may comprise event data display element 430. Event data display element 430 may enable playback of event data. The event data may comprise audio data from which the report provided the element 410 was generated. The event data may comprise video data. The video data may comprise video data captured concurrently with the audio data. The video data may comprise video data captured by a same recording device as the audio data. The event data may comprise video data associated with a same incident as the audio data. Element 430 may enable playback of both audio data and video data. Element 430 may enable frame by frame playback of audio data. Element 430 may further enable frame by frame playback of video data associated with the audio data.

In embodiments, event data display element 430 may enable playback of audio data. For example, element 430 may comprise a playback control element 440. Playback control element 440 may enable audible output of audio data. Playback control element 440 may enable selectively starting and stopping of audible output of audio data. Playback control element 440 may enable selection of a frame of audio data for subsequent playback. The frame may be a next frame audibly output by a computing device upon playback of the audio data. Playback control element 440 may present information regarding a set of audio data. For example, element 440 may visually indicate a length of the audio data, an amplitude of an audio signal captured in the audio data, and/or a playback position within the audio data. The playback position may indicate a next frame to be audibly output upon playback of the audio data. The playback position may indicate a most recently output frame of the audio data. The playback position may indicate a relative position within the idea data. For example, the playback position may indicate a relative amount of the audio data that has been played and/or remains to be played upon further playback of the audio data. Playback control element 440 may comprise an indicator 442 associated with the playback position. In some embodiments, playback control element 440 may comprise a playback bar. In some embodiments, indicator 442 may comprise a slider. Indicator 442 may be selectively positioned along a playback bar of the playback control element. In some embodiments, selecting a frame of audio data for subsequent playback may comprise repositioning indicator 442 within element 440.

In embodiments, providing 340 may comprise providing report data and audio data via a user interface. For example, providing 340 may comprise providing text data of a report associated with an incident via element 410 and event data associated with the incident via element 430. Providing 340 may comprise transmitting the report data and the event data to a client computing device for output to a user. Providing 340, may comprise, by at least one computing device, providing a report for display via a user interface. Providing 340, may comprise, by at least one computing device, providing audio data for audible output via a user interface. Providing 340 may comprise providing visual information of the report and visual information associated with the audio data for display via a visual user interface. In some embodiments, providing 340 may comprise providing video data associated with audio data for display via a same user interface as the report data and the audio data. A visual indication of the audio data may also be presented by a same user interface. For example, providing 340 may comprise displaying playback control element 440 and text display element 410 via a same user interface 400. In accordance with audio data and a computer-generated report being presented via same user interface, verification of the report relative to the event data may be enabled. Such an arrangement may enable accuracy of the computer-generated report to be reviewed prior to submission of the report.

In embodiments, providing 340 may comprise providing the report via a user input element. Providing 340 may comprise providing the report in an editable format. The user input element may enable the report to be edited. The user input element may enable a portion of the report to be selected. For example, element 410 may comprise an editable text box. A narrative portion of the report may be provided via element 410. Element 410 may enable one or more words of the report to be edited. For example, element 410 may enable one or more words to be added, changed, and/or deleted from a computer-generated report. By providing the report via a user input element, report information of the report may be modified, adjusted, or otherwise improved by an end user of a computing device on which the user input element is displayed.

In embodiments, providing 340 may comprise providing the report for selection. Providing 340 may comprise enabling at least a portion of the report to be selected. For example, element 410 may enable one or more words of a narrative portion of her report to be selected. the portion of the report may be selected via a user input. The portion of the report may be selected after the report has been displayed via a user interface device.

In embodiments, a selection of a subset of the report may be provided. The subset may comprise at least a portion of the report. The subset may comprise less than all of the report. For example, method 300 may comprise receiving 350 a selection of a subset of the report. The selection may be received via a user interface device of a computing device. For example, the selection may be received one or more of a keyboard, mouse, or touch screen of a client computing device. The selection may comprise one or more words of the report. The selection may comprise a sentence of the report. The selection may comprise a sequence of tokens of the report. For example, receiving 350 may comprise receiving a selection 420 of a subset of the report. Receiving 350 may comprise receiving an indication of the subset of the report. In some embodiments, receiving 350 may comprise identifying an unselected, second subset relative to the subset identified via the selection.

In embodiments, receiving 350 may comprise visually distinguishing the selected subset of the report. The subset of the report may be distinguished relative to other portions of the report that are unselected. For example, receiving 350 may comprise modifying a color, emphasis, or other visual characteristic of or more words selected via selection 420.

In embodiments, automatic identification of a subset of audio data associated with a subset of a report may be provided. The identified subset may enable the subset of the report to be verified. The identified subset may enable additional information associated with the subset of the report to be efficiently accessed. The identified subset may filter the subset of audio data relative to other subsets of the audio data, thereby decreasing a time necessary to review the subset of audio data associated with the subset of the report. For example, method 300 may comprise identifying 360 a subset of audio data associated with the subset of the report. The subset may comprise less than all of the audio data.

In embodiments, identifying 360 may comprise matching the subset of the report with the subset of audio data. The matching may be based on at least one indication associated with this subset of the report. For example, the report may comprise an indication for each portion of text information in the report that indicates a location in a transcript from wish the report was generated. The indication may comprise, for example, a timestamp. Matching the subset of the report with the subset of the audio data may comprise identifying a location in the audio data that further corresponds to the location indicated by the indication for a selected portion of our report. For example, a subset of a report associated with selection 420 may comprise a timestamp. The timestamp may correspond to a timestamp in a transcript upon which the report was generated. Identifying 360 may comprise identifying a frame of audio data associated with a same timestamp as the time stamp associated with the subset of the report selected via selection 420. Identifying 360 may comprise matching an indication of a location associated with the report to an indication of a location in the audio data. In accordance with matching the location indicated in the report to a location in the audio data, the subset of the audio data that corresponds to the selected subset of the report may be identified.

In embodiments, identifying 360 may comprise correlating one or more indications of the report with one or more corresponding locations within audio data. The one or more indications of the report may enable direct correlation between a subset of the report associated with the one or more indications with the one or more corresponding locations within audio data. For example, a subset of a report associated with selection 420 may comprise a plurality of timestamps indicating portions of a transcript from which the subset was generated. Identifying 360 may comprise identifying corresponding timestamps in the audio data that match the plurality of timestamps to identify the subset of the audio data.

In embodiments, identifying 360 may comprise identifying a range of audio data. The subset of the report may be associated with a plurality of indications relative to a transcript, wherein each indication comprises a different logical association between a portion of the report and a portion of the transcript. Identifying 360 may comprise combining a plurality of indications associated with the subset of the report selected upon receiving to identify a continuous range or set of ranges within the transcript. Identifying 360 may comprise indicating a corresponding set or sets of locations associated with the range or set of ranges of the transcript to identify the subset of the audio data.

In embodiments, identifying 360 may comprise providing a visual indication of the subset of the audio data. Identifying 360 may comprise generating the visual indication. The visual indication may be provided via display of a computing device. For example, the visual indication may be provided via user interface 400 displayed on a client computing device. The visual indication may identify a period of time associated with the audio data. For example, visual indication 444 may be provided on a progress bar. Visual indication 444 may visually indicate a period of time within an overall duration of the audio data. The overall duration may be displayed via playback control element 440. In some embodiments, visual indication 444 may be associated with a chronologically oldest timestamp and a chronologically most recent timestamp of a plurality of timestamps associated with a selected subset of a report. Such timestamps may enable a full range of source audio data to be indicated via a visual indication 444.

In embodiments, identifying 360 may comprise selecting the subset of audio data for playback. Identifying 360 may comprise selecting a playback location within the subset of audio data. A first frame of the subset may be selected upon identifying 360. Identifying 360 may comprise selected an earliest chronological part of the subset of the audio data associated with the subset of the report. For example, a first captured frame of a subset of audio data may be selected for subsequent output upon playback of the audio data. Selecting the subset of audio data may comprise repositioning a playback location from a current location within the audio to an updated location within the audio data that is associated with the subset of audio data. Selecting the subset of audio data may comprise selecting an updated playback location that is chronologically earlier or later than a current playback location.

In some embodiment, selecting the subset of audio data may comprise positioning a control of a user interface. The control may comprise a slider of a playback control element. For example, identifying 360 may comprise positioning playback control element 440 within the subset of audio data indicated via element 440. Selecting the subset of audio data may comprise repositioning the playback control element. For example, selecting the subset of audio data may comprise repositioning indicator 442 from a first location along playback control element 440 to a second location along playback control element 440. The second location may comprise a location that corresponds to a location of a plurality of locations along playback control element 440 associated with the subset of the audio data. In accordance with the positioning of the control of the user interface, a user may be visually informed that the subset of audio data may be played back upon receipt of further instruction via the user interface to playback event data.

In some embodiments, identifying 360 may comprise selecting a subset of video data for playback. The subset of video data may correspond to the subset of audio data. For example, a frame of the subset of audio data may be associated with a corresponding frame of the video data. Each frame may have been captured at a same time during recording of event data comprising the audio data and the video data. Identifying 360 may comprise selecting a playback location within video data associated with the subset of video data. Upon subsequent playback of event data comprising the video data and the audio data, and in accordance with the selected playback location within the video data, playback of the subset video data via a user interface may be initiated. Identifying 360 may comprise updating element 430 to display a frame of the subset of video data. Element 430 may be updated from displaying a different frame of video data to instead display the frame of the subset of video data upon identifying 360.

In embodiments, an automatically generated report may be edited. For example, method 300 may comprise receiving 370, by the at least one computing device, a revision to the report via a user interface. Receiving 370 may be provided after providing 340. Receiving 370 may be provided after receiving 350 or after identifying 360. Receiving 370 may comprise receiving one or more user inputs for modifying the report. For example, the one or more user inputs may indicate text that should be added, deleted, or relocated within the computer-generated report. The one or more user inputs may be received via user interface device. For example, receiving 370 may comprise receiving one or more user inputs to edit the generated report via a keyboard, mouse, and/or touchscreen device of a client computing device. In some embodiments, receiving 370 may comprise modifying the report at a selected location of the report. The selected location may comprise a location within a report selected upon receiving 350 a selection. In embodiments, receiving 370 may comprise modifying the report at a location indicated in the report upon generation of the report by a generative computing device.

In embodiments, providing 340 may comprise inserting verification information in an automatically generated report. The verification information may be unrelated to an event for which the report is generated. The verification information may comprise predetermined information. The verification information may comprise information not represented in a prompt. For example, the verification information may comprise one or more predetermined words. The verification information may comprise one or more nouns that are both unrelated to the event and non-represented in event data. The verification information may be distinct from the information provided to and/or received from a generative computing device. For example, remote computing device 140 may store a predetermined list of words that may be automatically added to the report. Prior to adding the verification information, remote computing device 140 may compare one or more words from the list to information in the report to confirm that the one or more words do not match the information in the report. The verification information may ensure that an automatically generated report has been presented to a prior to submission. The verification information may comprise information designed to be deleted upon receiving one or more revisions to an automatically generated report. For example, the verification information may comprise one or more words designed to be edited upon receiving 370 a revision to a report. Providing 340 may comprise inserting the verification information in an automatically generated report after the automatically generated report has been generated by a generative computing device. For example, remote computing device 140 may insert verification information into a report received from generative computing device 160 prior to the report being provided to a client computing device for display.

In embodiments, receiving 370 may comprise receiving a revision of verification information. The revision may be received for verification information added to a report upon providing 340. The revision may remove the verification information.

In embodiments, receiving 370 may comprise generating an alert. The alert may be generated when the revision is not applied to verification information. The alert may be generated when at least one revision received upon receiving 370 does not correspond to verification information. The alert may be generated prior to submission of a report. In some embodiments, the alert may prevent a report from being submitted. In accordance with generating an alert, embodiments according to various aspects of the president disclosure may ensure that information in an automatically generated report has been properly displayed. The verification information may provide a technical benefit for ensuring that a complete set of information automatically generated for a report has been displayed for review by an end user.

In embodiments, receiving 370 may comprise requiring revision of the verification information. The revision may be required prior to subsequent processing of the report. The revision may be required prior to transmission and/or storage of the report. For example, receiving 370 may comprise requiring a revision to a report to be received from client computing device 170 prior to storage of the report by data store 150 or remote computing device 140 or submission of the report data store 150 or remote computing device 140. In some embodiments, requiring the revision may comprise requiring the verification information to be deleted from the report. By requiring the verification information to be deleted, embodiments according to various aspects of the present disclosure may ensure that automatically generated portions of the prior to and/or after the report have been displayed for review.

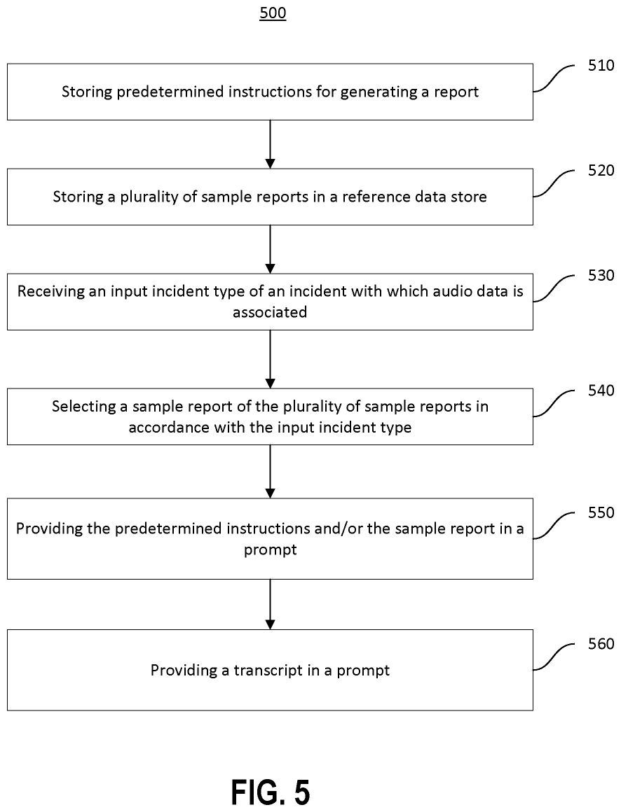

In embodiments, automatically generating a report may comprise generating a prompt. For example, and with brief reference to FIG. 5, embodiments according to various aspects of the present disclosure may comprise one or more operations of method 500 for generating a prompt. Method 500 may comprise one or more operations for automatically generating the prompt. The prompt may be automatically generated after audio data is received by a computing system. In some embodiments, one or more operations of method 500 may be performed automatically after an instruction to generate a report is received. The instruction, in some embodiments, may comprise an indication of event data for which the report should be generated. Method 500 may be performed by one or more computing devices disclosed herein. For example, one or more operations may be performed by remote computing device 140 and/or data store 150 with brief reference to FIG. 1. In some embodiments, the one or more operations may be performed by system 200, with brief reference to FIG. 2, configured to perform one or more operations of a computing device and/or data store. In embodiments, method 500 may comprise one or more of storing 510 predetermined instructions for generating a report, storing 520 a plurality of sample reports in a reference data store, receiving 530 an input incident type of an incident with which audio data is associated, selecting 540 a sample report of plurality of sample reports in accordance with an input incident type, providing 550 the predetermined instructions and/or the sample report in a prompt, and/or providing a transcript of audio data in a prompt. In embodiments, and with brief reference to FIG. 3, generating 330 a prompt comprising the transcript may comprise one or more operations of method 500. For example, generating 330 may comprise one or more of receiving 530, selecting 540, and/or providing 550.

In embodiments, generating a prompt may comprise storing predetermined instructions for generating the report. The instructions may be generated prior to capture of audio data by a recording device. The instructions may comprise a set of information associated with generating a report. The instructions may comprise a set of rules associated with generating a report. In some embodiments, the set of information may enable a general-purpose machine learning model to transform unstructured text data in a transcript into structured text data for a report. For example, method 500 may comprise storing 510 predetermined instructions for generating a report. The predetermined instructions may be stored in a non-transitory, computer readable storage medium. For example, storing 510 may comprise string the predetermined instructions in at least one of memory 204 and/or storage medium 208 with brief reference to FIG. 2.

In some embodiments, storing 510 may comprise receiving the instructions. The instructions may be received from a client computing device. For example, storing 510 may comprise receiving the instructions from client computing device 170 with brief reference to FIG. 1. In some embodiments, the instructions may be received from a client computing device different from another client computing device by which a report is subsequently provided. For example, the instructions may be received from a first client computing device and a report generated based on the instructions may be displayed by a second client computing device different from the first computing device.

In embodiments, storing 510 may comprise storing the instructions for use with generating a plurality of reports. The same instructions may be stored for generating each of the plurality of reports. The same instructions may be stored prior to generating reports for reports based on event data captured by a plurality of respective recording devices. For example, storing 510 may comprise storing the same instructions for subsequent use in generating a respective report for event data captured by each of first recording device 112, second recording device 114, and third recording device 116.

In embodiments, automatically generating a prompt may comprise storing at least one sample report in a reference data store. The at least one sample report may comprise a plurality of sample reports. The plurality of sample reports may be collectively stored in a reference data store. The plurality of sample reports may provide reference information for the generation of subsequent reports. For example, the plurality of sample reports may indicate a grammar, style, chronology, and/or vocabulary with which a subsequent, computer-generated report should be generated by a generative computing device. For example, method 500 may comprise storing 520 a plurality of sample reports in a reference data store.

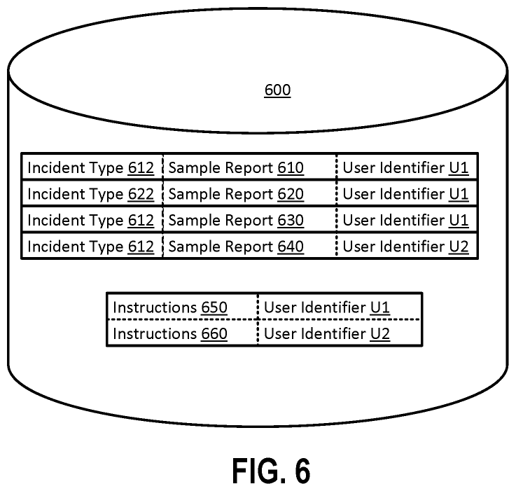

In embodiments, a reference data store may store information used to generate a prompt. The reference data store may store a plurality of sample reports. For example, and with reference to FIG. 6, reference data store 600 may be used to generate a prompt. Reference data store 600 may store a plurality of sample reports. For example, reference data store 600 may store first sample report 610, second sample report 620, third sample report 630, and fourth sample report 640. In embodiments, each report of the plurality of reports may be associated with an incident type and/or an entity identifier. A sample report may be logically associated with an incident type and/or an entity identifier. For example, a sample report may comprise metadata indicating an incident type associated with the sample report and/or an entity identifier associated with the sample report. In embodiments, each sample report may be indexed in accordance with an incident type associated with the sample report and/or the entity identifier associated with the sample report.

In embodiments, information stored in a reference data store may alternately or additionally comprise predetermined instructions with which a prompt may be generated. The instructions may comprise instructions stored upon storing 510. The instructions may comprise a plurality of instructions. For example, reference data store 600 may store first predetermined instructions 650 and second predetermined instructions 660. In some embodiments, separate predetermined instructions may be stored for different entities. For example, first predetermined instructions 650 may be associated with first entity identifier U1 associated with a first entity and second predetermined instructions 660 may be associated with second entity identifier U2 associated with a second entity. The different predetermined instructions may enable the predetermined instructions to be customized for different entities. In other embodiments, a reference data store may store a single set of predetermined instructions that are used to generate each of a plurality of prompts for same or different entities. In some embodiments, sample reports and/or predetermined instructions may be stored in one or more storage mediums. For example, data store 600 may be provided via a at least one non-transitory storage medium of one or more of remote computing device 140 and/or data store 150 with brief reference to FIG. 1.

In embodiments, storing a plurality of sample reports may comprise receiving each report of the plurality of sample reports from a client computing device. For example, storing 520 may comprise receiving the sample reports from client computing device 170 with brief reference to FIG. 1. In some embodiments, the sample reports may be received from one or more client computing devices different from another client computing device by which a report is subsequently provided. For example, the instructions may be received from first and second client computing devices and a report generated based on the instructions may be displayed by a third client computing device different from each of the first and second computing devices. In some embodiments, receiving a sample report of the plurality of sample reports may comprise received a selection of the sample report and/or received an uploaded sample report. The selection and/or the uploaded sample report may be received via a client computing device.

In embodiments, storing the plurality of sample reports may comprise storing the plurality of sample reports prior to receiving a transcript of audio data. The sample reports may be selected, generated, or otherwise provided for storage prior to capture of event data for which the sample reports are used to generate a report. The sample reports may be stored independent of a subsequently received transcript for which a report is generated using at least one of the sample reports. For example, storing 520 may be performed prior to receiving 310 with brief reference to FIG. 3. Storing 520 may comprise storing the plurality of sample reports in data store 600 prior to audio information 120 being captured by recording device 110 with brief reference to FIGS. 1 and 6. The plurality of sample reports may be stored independent of when audio data may be subsequently received.

In embodiments, each sample report of the plurality of sample reports may be associated with an incident type of a plurality of incident types. Storing 520 may comprise storing a sample report with an incident type of the sample report. Storing 520 may comprise storing a respective incident type for each sample report of a plurality of sample reports. The incident type may indicate a type of event with which the sample report is associated. For example, first sample report 610 may be associated with first incident type 612, second sample report 620 may be associated with second incident type 622, third sample report 630 may be associated with first incident type 612, and/or fourth sample report 640 may be associated with first incident type 612. The incident type may further indicate a type of event represented in the sample report. In embodiments, the incident type may identify a type of law enforcement-related event. For example, the incident type may be associated with at least one of assault, battery, damage to property, traffic accident, and theft. In some embodiments, the incident type associated with a sample report may comprise a reference incident type. The reference incident type may match or, alternately, may not match an input incident type associated with a transcript for which a new report may be generated. In accordance with matching or not matching, a sample report with the reference incident type may be used or not used to subsequently generate a report for audio data with which the input incident type is associated.

In embodiments, the plurality of incident types of the plurality of sample reports may comprise different incident types. For example, the plurality of incident types may comprise first incident type 612 and second incident type 622 different from first incident type 612. The different incident types may indicate different events for which event data may be recorded. The different incident types may identify different events with which event data may be associated. The different incident types may identify different events for which reports may be automatically generated. In embodiments, the different incident types may be associated with different types of law enforcement-related events. For example, the plurality of incident types at least two of assault, battery, damage to property, traffic accident, and theft.

In embodiments, a sample report associated with a given incident type may comprise one or more features. The features may be selected in accordance with the given incident type. For example, first sample report 610 may be associated with first incident type 612. First sample report 610 may comprise one or more features associated with first incident type 612. For example, first incident type 612 may indicate burglary and first sample report 610 may comprise content indicating a location of a burglary and one or more missing items. The one or more features of first sample report 610 may indicate an order in which the location and the one or more missing items are presented and/or a manner in which the location and missing item(s) are presented in the report.

In embodiments, each incident type of the plurality of incident types may comprise a unique identifier. The unique identifier may comprise a unique alphanumeric identifier. The unique identifier may comprise a unique offence code. The unique identifier may be associated with a type of legal infraction to which an associated sample report corresponds. The unique identifier may enable a sample report associated with a given incident type to be differentiated from other sample reports associated with other incident types different from the given incident type. For example, first incident type 612 may comprise a first unique identifier and second incident type 622 may comprise a second unique identifier.

In embodiments, the plurality of sample reports may comprise sample reports associated with different incident types. For example, the plurality of sample reports may comprise first sample report with a first incident type and a second sample report associated with a second incident type of the plurality of incident types, wherein the first sample report different from the second sample report and the first incident type different from the second incident type. For example, first sample report 610 may be associated with first incident type 612, while a second sample report 620 may be associated with second incident type 622 different from first incident type.

In embodiments, sample reports associated with different incident types may comprise different features. For example, content of a sample report associated with an incident type of a burglary may indicate a building that has been burglarized, while a sample report associated with an assault may indicate a victim of the assault. The sample report may lack information regarding a victim and the sample report may lack information regarding a building. In accordance with different incident types, the features that should be included or excluded in subsequently generated reports for different incident types may be indicated via the features that are represented in a sample report associated with respective, corresponding different incident types. Such an arrangement may provide a particular technical benefit for drafting customized reports using a common generative computing device and/or common model.

In embodiments, a sample report may be associated with an entity identifier. Each sample report of a plurality of sample reports may be associated with a respective entity identifier. For example, first sample report 610 may be associated with first entity identifier U1, second sample report 620 may be associated with first entity identifier U1, third sample report 630 may be associated with first entity identifier U1, and/or fourth sample report 640 may be associated with second entity identifier U2. An entity identifier may indicate a source of the sample report. The entity identifier may indicate an entity with which the sample report is associated. For example, the entity identifier may indicate one or more of a user that provided the sample report and/or an agency from which the sample report was provided. The user may comprise an individual person. The person may be associated with a same or different agency as another person for which a respective sample report is stored. For example, first entity identifier U1 may be associated with a first user and/or a first agency and second entity identifier U2 may be associated with a second user and/or a second agency respectively different from the first user and/or the first agency. In other examples, first and second entity identifiers may respectively refer to different persons associated with a same agency. The entity identifier may enable a sample report to be subsequently selected for an entity associated with the entity identifier. Storing 520 may comprise storing a sample report with an entity identifier of the sample report.

In some embodiments, a sample report may be associated with an entity in accordance with a manner in which the sample report is stored. For example, one or more the sample reports associated with a given entity may be stored in a separate data store relative to one or more other data stores in which one or more sample reports for which one or more different entities may be respectively stored. For example, and with brief reference to FIG. 1, data store 150 may comprise a different data store for each entity of a plurality of entities. Each entity of the plurality of entities may be associated with a respective entity identifier of the plurality of entity identifiers. The plurality of data stores may comprise different data stores for different users and/or different data stores for different agencies. For example, reference data store 600 may be associated with one entity and/or entity identifier of a plurality of entity identifiers, while other entity identifiers of the plurality may be associated with separate, respective reference data stores. In such an arrangement, the reference data stores for different entities and/or different entity identifiers may comprise different sample reports. The different data stores may comprise different sample reports for same incident types. For example, a first data store associated with the first entity may comprise a first sample report for an incident type and a second reference data store associated with the second entity may comprise a second, different sample report for the incident type. Such an arrangement may enable different entities to selectively provide different instructions, rules, and/or information upon which a computer-generated report may be generated for the respective entity. In accordance with the different sample reports for different entities, some embodiments according to various aspects of the present disclosure may provide a technical benefit in the context of report generation for law-enforcement or security-related events, whereby a same machine learning model and/or a same generative computing device may be enabled to provide customized reports for different entities for common incident types.

In embodiments, an input incident type may be received. The input incident type may comprise an incident type associated with a transcript. The input incident type may indicate an incident type associated with audio data from which the transcript was generated. For example, method 500 may comprise receiving 530 an input incident type of an incident with which audio data is associated. Upon receiving 530, the input incident type may be available for subsequent processing for automatically generating a report.

In some embodiments, receiving 530 may be associated with a manual input received by a computing device. For example, the input incident type may be provided by a user via client computing device. Alternately or additionally, the input incident type may be provided via a recording device. Receiving 530 may comprise receiving, by remote computing device 140, an input incident type via one of recording device 110 or 170 with brief reference to FIG. 1.

In some embodiments, receiving 530 may comprise receiving the input incident type with audio data. For example, receiving 310 may further comprise receiving an input incident type for the audio data with brief reference to FIG. 3. The input incident type may be indicated in metadata for the audio data. For example, remote computing device 140 may receive an input incident type with metadata uploaded with audio data from recording device 110. Alternately or additionally, the input incident type may be received separate from audio data. For example, remote computing device 140 may receive information indicating an input incident type from recording device 110 or client computing device 170 separate from audio data provided by 110. The information may further indicate the audio data with which the input incident type is associated.

In embodiments, receiving the input incident type may comprise automatically detecting the input incident type from at least one of the audio data and/or a transcript of the audio data. A computing device may be configured to analyze audio data and/or a transcript of the audio data in order to automatically generate the input incident type associated with the audio data. For example, remote computing device 140 may be comprise a trained machine learning model configured to output an input incident type upon application of the trained machine learning model to at least one of audio data and/or a transcript of the audio data. Remote computing device 140 may be configured to automatically detect the input incident type upon receiving 310 the audio data or transcribing 320. Receiving 530 may comprise applying, by a computing device, one or more logical operations to at least one of the audio data and/or a transcript of the audio data to detect the input incident type. Receiving 530 may comprise generating, by a computing device, the input incident type based on at least one of the audio data and/or a transcript of the audio data. Receiving 530 may comprise analyzing at least one of the audio data and/or a transcript of the audio data to detect the input incident type.

In embodiments, at least one sample report may be used to automatically generate a report. The at least one sample report may provide a template for generating the report. For example, the at least one sample report may indicate one or more styles, formats, and/or phrasings with which a report should be generated. The sample report may comprise at least one sample report received upon receiving 530. The sample report may be selected from a database. For example, the sample report may comprise at least one sample report selected from reference data store 600.

In embodiments, the at least one sample report may be selected from a plurality of sample reports. The sample report may comprise a subset of the plurality of sample reports. The subset may comprise less than all of the plurality of sample reports. For example, the at least one sample report may comprise first sample report 610, third sample report 630, and fourth sample report 640 of the plurality of sample reports stored in data store 600.

In some embodiments the at least one sample report may be selected in accordance with an input incident type. The input incident type may enable the at least one sample report to be identified relative to a plurality of sample reports. In accordance with the input incident type, the generation of a subsequent report may be automatically modified relative to the input incident type in accordance with information further provided via the at least one sample report. For example, method 500 may comprise selecting 540 at least one sample report of a plurality of sample reports in accordance with an input incident type. The plurality of sample reports may comprise a plurality of sample reports stored upon storing 520. Selecting 540 may be performed after storing 520. The input incident type may comprise an input incident type received upon receiving 530. Selecting 540 may enable a basis on which a report is generated to be adapted to the incident type represented in the audio data for which the report is generated. For example, and in accordance with information provided via the at least one sample report, selecting 540 may enable information that is included a transcript to be included, excluded, or otherwise selectively provided in the generated report in accordance with the manner in which related information is provided in the at least one sample report. In some embodiments, selecting 540 may be performed automatically upon receiving 530. In some embodiments, selecting 540 may be automatically performed after receiving 310 or after transcribing 320. Selecting 540 may enable a subsequently generated report to be automatically generated based on the at least one sample report selected upon selecting 540.

In embodiments, selecting a sample report may comprise obtaining a copy of the at least one sample report. For example, selecting 540 may comprise obtaining data from at least one sample report. Text information from the at least one sample report may be downloaded from a database in which the at least one sample report is stored. Selecting 540 may comprise receiving text information associated with the at least one sample report responsive to submitting a request for one or more sample reports. Selecting 540 may comprise receiving the at least one sample report at a same computing device from which a request was received. For example, selecting 540 may comprise receiving the at least one sample report at remote computing device 140. The at least one sample report may be received from data store 150 with brief reference to FIG. 1.

In embodiments, selecting a sample report comprises selecting the sample report in accordance with a user identifier. For example, selecting 540 may comprise selecting at least one sample report in accordance with a user identifier. The user identifier may be received by a computing device. For example, remote computing device 140 may receive a user identifier. The user identifier may comprise a user identifier received with audio data. For example, a user identifier may be uploaded with event data for which a report may be subsequently generated. Alternately or additionally, the user identifier may be provided upon receipt of a request to generate a report. In embodiments, the user identifier may comprise a unique identifier for a person and/or an entity with which event data is associated. In embodiments, a received user identifier may further correspond to at least one user identifier stored in a reference data store. For example, selecting 540 may comprise receiving first user identifier U1.

In some embodiments, a sample report for a given entity may be selected in accordance with searching the data store associated with the given entity. In such embodiments, sample reports for the given entity may not require or otherwise be stored with an entity identifier. Rather, an instruction to automatically generate a report for a given entity may comprise automatically searching or otherwise routing a request to retrieve one or more sample reports for inclusion in a prompt to the data store associated with the given entity. Different entities, associated with different respective user identifiers, may be associated with different data stores. Each user identifier of a plurality of user identifiers may be associated with a different reference data store comprising a different plurality of sample reports. First user identifier U1 may be associated with a first reference data store and second user identifier U2 may be associated with a second reference data store. In accordance with a received user identifier. For example, selecting 540 the sample report may comprise selecting a sample report from the data store associated with the given entity. Selecting the sample report in accordance with a user identifier may comprise transmitting a request for the sample report based on the use identifier. A request to select one or more sample reports may be routed or otherwise transmitted to a reference data store associated with the received user identifier. In accordance with such an arrangement, the number of sample reports searched for potential inclusion in a prompt for a given entity may be decreased relative to embodiments in which a data store stores different sample reports for a plurality of entities.

In embodiments, selecting the sample report in accordance with a user identifier may comprise searching a plurality of sample reports based on the use identifier. A reference data store may comprise a plurality of sample reports. The plurality of sample reports may comprise one or more sample reports for each user identifier of a plurality of identifiers. For example, data store 600 may comprise one or more sample reports for each of first user identifier U1 and second user identifier U2. Selecting 540 may comprise matching a received user identifier to a respective user identifier for each of a plurality of sample reports. For example, selecting 540 may comprise matching a received user identifier U1 with the user identifiers associated with each of first sample report 610, second sample report 620, and third sample report 630. These reports may be further processed for inclusion or exclusion as at least one sample report from which a report may be subsequently automatically generated. However, and in accordance with the received user identifier U1, selecting 540 may comprise determining that fourth sample report 640 is associated with a different user identifier. In accordance with this determination, fourth sample report 640 may be excluded from the at least one sample report selected upon selecting 540. Selecting 540 may comprise excluding and/or not selecting at least one sample report in accordance with a user identifier.

In embodiments, selecting a sample report may comprise determining the incident type associated with the sample report corresponds to the input incident type. For example, selecting 540 may comprise determining the incident type associated with the sample report corresponds to the input incident type. The input type may comprise an input incident type. The incident type may comprise an incident type received upon receiving 530.

In embodiments, selecting a sample report may comprise matching the input incident type with an incident type associated with the sample report. The input incident type may be used as an index to identify a subset of sample reports stored in a database that are associated with the input incident type. The input incident type may be identical to a reference incident type respectively stored with each of a plurality of sample reports. Matching the incident type may comprise matching a unique identifier of the input incident type with a unique identifier of the incident type of the sample report. For example, selecting 540 may comprise selecting at least one sample report based on an input incident type comprising first incident type 612. Selecting 540 may comprise comparing this the input incident type to the respective reference incident types stored with each of first sample report 610, second sample report 620, third sample report 630, and fourth sample report 640. Selecting 540 may comprise matching the input incident type to a subset of the reports 610-640. For example, an input incident type comprising first incident type 612 may be matched with reference incident types for each of first sample report 610, third sample report 630, and fourth sample report 640. Second sample report 620 may not be matched with the input incident type in this example in accordance with second sample report 620 comprising a different associated reference incident type, second incident type 622.

In embodiments, selecting 540 may comprise selecting multiple sample reports of a plurality of sample reports. The multiple sample reports may include two or more sample reports of the plurality of sample reports. For example, selecting 540 in accordance with an input incident type comprising first incident type 612 may comprise selecting each of first sample report 610, second sample report 620, and third sample report 630. In some embodiments, a minimum and/or maximum number of sample reports may be selected. For example, the minimum or maximum number may comprise three sample reports in accordance with various aspects of the present disclosure.

In embodiments, selecting 540 may comprise selecting at least one sample report in accordance with each of a user identifier and an incident type. Each of the incident type and user identifier may be applied to adapt a subsequently generated report to a particular entity and incident type. For example, selecting 540 in accordance with an entity corresponding to first user identifier U1 and input incident type comprising first incident type 612 may comprise selecting each of first sample report 610 and third sample report 630. However, second sample report 620 and fourth sample report 640 may not be selected in accordance with these reports being associated with a different reference incident type and a different user identifier respectively.

In embodiments, a prompt may be generated. The prompt may enable a report to be automatically generated for corresponding event data. The event data may comprise event data received upon receiving 310. Generating the report may comprise providing different sets of information in a common request. For example, method 500 may comprise providing 550 at least one of predetermined instructions and/or at least one sample report in a prompt. The at least one sample report may comprise the sample report selected upon selecting 540. Providing 550 may comprise receiving the predetermined instructions stored upon storing 510. The predetermined instructions may be received responsive to an automatically generated request. In embodiments, generating 330 may comprise adding the at least one of predetermined instructions and/or at least one sample report provided upon providing 550 to a prompt. Providing 550 may comprise including text information in the prompt that respectively identifies the text information from each of the predetermined instructions and/or at least one sample report.

In embodiments, providing 550 may comprise providing predetermined instructions in accordance with a user identifier. The user identifier may be associated with audio data for which a report may be generated. The user identifier may comprise an input user identifier. Providing 550 may comprise matching the user identifier with a reference user identifier to select predetermined instructions. For example, an input identifier comprising first user identifier U1 may be associated with first predetermined instructions 650, while an input user identifier comprising second user identifier U2 may be associated with second predetermined instructions 660. Providing 550 may comprise providing predetermined instructions in accordance with matching an input user identifier with a reference user identifier associated with the predetermined instructions.

In embodiments, a prompt may comprise information regarding an event for which a report is subsequently generated. The information regarding the event may be captured in audio data recorded at a location associated with the event. The information may comprise a transcript of the audio data associated with the event. For example, method 500 may comprise providing 560 a transcript of audio data in a prompt. The transcript may comprise the transcript generated upon transcribing 320. Providing 560 may comprise combining text information from the transcript with text information from the predetermined instructions and/or the at least one sample report provided upon providing 550. In embodiments, generating 330 may comprising providing 550 and providing 560.

In embodiments, a prompt may be generated to be provided as input to a generative machine learning model. Generating the prompt may comprise receiving and/or accessing various information for inclusion in the prompt. The prompt may be generated on a same or different computing device on which the generative machine learning model is executed. For example, and with brief reference to FIG. 1, remote computing device 140 may be configured to automatically generate a prompt for transmission to generative computing device 160.

In embodiments, a prompt may comprise various rules associated with a report. Predetermined instructions for generating a report may comprise the various rules. For example, the predetermined instructions stored upon storing 510 may comprise various rules. The rules may enable a generative computing device to generate a report usable in the context of a law enforcement or other security related event. The rules may indicate characteristics of text data that preferred or required to be included and/or excluded for a report. The rules may indicate grammatical characteristics of text generated for a report. The rules may identify features that should or should not be represented in a report generated for subsequent use in a legal context. The rules, upon being processed by a generative computing device, may logically indicate information that is subsequently included or excluded in a generated report, as well as a manner in which the information is included in the report. The rules may enable unstructured data comprising a transcript to be transformed into structured data for a report. For example, the information may enable multiple statements from dialogue between two or more persons captured in audio information 120 to be transformed into narrative information for a narrative portion of the report. In some embodiments, the rules may enable multiple sources of information to be restructured to represent a single source among the multiple sources. The single source may comprise a user of a recording device that captured the audio data for which the report is subsequently generated.

In embodiments, the rules may comprise at least one perspective rule. The perspective rules may indicate a perspective. For example, the rules may indicate that a first-person perspective should be reflected in a report. The rules may indicate that the first-person perspective may be associated with a user of a recording device from which audio data was captured and transcribed to create a transcript that is included in a same prompt. The perspective rules may cause a generative model to rephrase or exclude information in a transcript from other perspectives into information provided from first-person perspective in a generated report.

In embodiments, the rules may comprise at least one content rule. The content rules may indicate subject matter from a transcript that should or should not be included in a generated report. For example, the content rules may indicate that a role of a person at an incident should be used instead of name of the person. The name of a person may initially be provided in the generated report, along with their role. Subsequent references to the person should refer to the indicated role in accordance with a content rule in embodiments. Alternately or additionally, the content rules may indicate that security-related jargon should or should not be included in the generated report, observations should or should not be included in the generated report and/or justifications should or should not be included in the report. By including a content rule in a prompt, a generative computing device may be automatically configured to select subject matter from a received transcript for inclusion or exclusion from a generated report. Alternately or additionally, the generative computing device may be automatically configured to add, or prevent from being added, additional words or phrases to the report in accordance with the content rule.

In embodiments, the rules may comprise a chronology rule. For example, the chronology rule may indicate a preferred order in which subject matter should be presented in an automatically generated report. In a transcript, subject matter may be presented in a first order. For example, the first order may be determined in accordance with a natural flow of dialogue between two or more persons. The chronology rule may indicate a second order for such information different from the first order. For example, a transcript may comprise A person's date of birth and then their name. However, a chronology rule may indicate that a person's name should be presented in a generator to report before their date of birth. By including a chronology rule in a prompt, a generative computing device may be automatically configured to transform information provided in the first order into information provided in the second order.

In embodiments, the rules may comprise formatting rules. The formatting rules may indicate one or more formatting-related features that are required to be reflected in an automatically generated report. The formatting rules may enable information provided in a dialogue format to be transformed into a predetermined written format. For example the formatting rules may indicate that one or more of headings, uncapitalized text, capitalized text, and/or bullet points should be used. By including at least one formatting rule in a prompt, a generative computing device may be configured to automatically apply a predetermined written format to unstructured information captured in received event information. The formatting rule or rules may enable the input information to be captured in a natural format while still enabling a subsequently generated report to be provided in a structured, predetermined format.

In embodiments, the rules may comprise placeholder rules. The placeholder rules may indicate how missing or non-audible information should be represented in an automatically generated report. For example, event data may comprise video and audio. The video may capture a color of a vehicle involved with a given incident. However, the color of the vehicle may not be captured in audio of the event data. A generative model may be configured to include color information regarding the vehicle in an automatically generated report. However, in this example, a color of a vehicle may not be represented in the audio data. Placeholder rules may indicate a manner in which the missing or non-audible information should be represented in the generated report. In some examples, the placeholder rules may indicate reference text that should be inserted where the missing or non-audible information should be inserted after the report is generated. The reference text may comprise predetermined text or information. For example, the reference text may comprise a phrase surrounded by brackets. The placeholder rules may indicate that the reference text should be inserted when a generative model determines that missing information and/or non-audible information for an event exists or is likely to exist. The placeholder rules may indicate that the generative model should insert the reference text in an automatically generated report when the generative model determines that the missing information and/or the non-audible information exists. In accordance with the placeholder rules, the missing information and/or non-audible information may be subsequently added by a user. For example, a revision to the reference text may be received upon receiving 370 with brief reference to FIG. 3.

In some embodiments, rules may correspond to information provided in one or more sample reports. The one or more sample reports may directly or indirectly indicate information represented in the rules. For example, the one or more sample reports may reflect logic represented in one or more of content rules and/or chronology rules. In accordance with the rules and the one or more sample reports, a generative computing device may be enabled to automatically generate a port based on information that is directly or indirectly included in each of the rules and the one or more sample reports. The combination of the one or more sample reports and the rules may increase a technical accuracy and/or completeness of a report that is automatically generated for newly received event data.

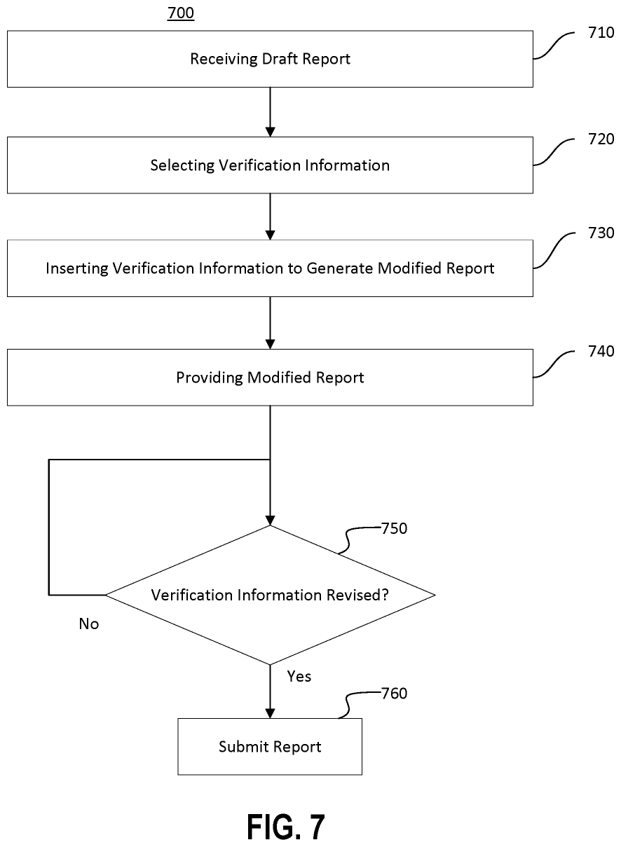

In embodiments, a method may be provided for verifying a report has been provided. For example, and with brief reference to FIG. 7, method 700 may comprise one or more operations for verifying a report has been provided. Method 700 may be performed by at least one computing system. For example, at least one computing device may comprise a processing circuit and at least one non-transitory computer-readable storage medium storing instructions that, when executed by the processing circuit, cause the at least one computing device to perform one or more operations disclosed herein. The at least computing device may comprise a computer-based system. For example, computer-based system 200 may be configured to perform one or more operations of method 700 with brief reference to FIG. 2. In embodiments, the at least one computing system may comprise one or more computing devices of a system for capturing event data associated with an incident. For example, and with brief reference to FIG. 1, remote computing device 140 may be configured to perform one or more operations of method 700. In alternate embodiments, alternate or additional computing devices may be configured to perform one or more operations of method 700. For example, and in some embodiments, one or more operations of method 700 may be alternately or additionally performed by recording device 110 and/or client computing device 170. In embodiments, method 700 may comprise one or more operations selected from the operations comprising receiving 710 a draft report, selecting 720 verification information, inserting 730 verification information to generate a modified report, providing 740 a modified report, determining 750 whether verification information has been revised, and/or submitting 760 a revised report.

In embodiments, a draft report may be received. For example, method 700 may comprise receiving 710 a draft report. The draft report may be a report received upon providing 340 with brief reference to FIG. 3. The draft report may be received from another computing device. For example, receiving 710 may comprise remote computing device 140 receiving the draft report from generative computing device 160. The draft report may be automatically generated. Each portion of the draft report may be output from a generative machine learning model applied to a prompt. The draft report may be unverified. For example, subsequent to generation of the report, the draft report may not be provided for display. The draft report may be unreviewed by an end user. The draft report may be generated based upon information in a prompt previously provided to a generative computing device. Providing 340, with brief reference to FIG. 3, may comprise receiving 710.

In embodiments, verification information may be selected for inclusion in a report. For example, method 700 may comprise selecting 720 verification information. The verification information may comprise predetermined text data. The verification information may indicate a text information to be inserted in a draft report. The verification information may comprise a sequence of tokens, wherein each token is associated with a character, word, or phrase. In some embodiments, the verification information may indicate a sentence. The verification information may be unrelated to the draft report. The verification information may be unrelated to a transcript upon which a draft report is generated. The verification information may comprise error information. The verification information may comprise an artificial error. The verification information may enable an artificial error to be intentionally inserted into a draft report. The verification information may comprise text information distinct from text information of a draft report. The verification information may be unassociated with report information in the draft report. Content of the verification information may lack a corresponding basis in a transcript upon which a draft report is generated. The verification information may be provided independent of a generative machine learning model by which a draft report may be generated. For example, the verification information may indicate text information that would not be included in a report. The verification information may be determined prior to receiving 710. The verification information may be determined prior to providing 340. For example, a plurality of sets of verification information may be stored in storage medium 208 prior to receiving 310 audio data with brief reference to FIG. 2-3.

In embodiments, selecting 720 may comprise selecting the verification information from a data store. For example, selecting 720 may comprise selecting the verification information from a data store in storage medium of remote computing device 140 or data store 150 with brief reference to FIG. 1. In some embodiments, the verification information may be randomly selected from the data store. In another embodiment, and just as an example, the verification information may be selected in a continuous order from the data store. After a first verification information of the data store has been selected for a first instance of selecting 720, a next instance of selecting may automatically cause a second, next verification information after the first verification information to be selected from the data store.

In embodiments, selecting 720 may comprise selecting a plurality of verification information. For example, verification information 226 may comprise a plurality of verification information, also referred to herein as sets of verification information. Each set of verification information may be associated with different subject matter. For example, each set of verification information may be associated with a different sentence. Selecting 720 may comprise selecting two or more sets of verification information from a data store comprising a plurality of verification information.

In embodiments, selecting 720 may comprise determining a number of verification information to be inserted. The number of verification information may be selected in accordance with a length of a report. For example, selecting 720 may comprise determining a length of the report. The length of the report may correspond to a number of words, sentences, and/or paragraphs provided in a draft report. Selecting 720 may comprise selecting the number of verification information in accordance with a threshold length of the report. For example, a threshold length may comprise a number of sentences, a number of paragraphs, and/or a number of words in a draft report. For each threshold length of the draft report, verification information may be selected. For example, a draft report may comprise twelve paragraphs and a threshold length for selecting verification information may comprise three paragraphs. In accordance with the example length of the example draft report, selecting 720 may comprise selecting four verification information from a plurality of verification information. In embodiments, a threshold length may comprise different numerical values, including those that are greater, lesser, and/or manually selected relative to the example threshold length in this example embodiment. In embodiments, each verification information of the plurality of verification information may be different. In embodiments, a threshold length of a report for which each verification information may be selected may be determined prior to receiving 710. In embodiments, a threshold length of a report for which each verification information may be selected may be determined independent of the draft report received upon receiving 710. A number or amount of the verification information selected upon selecting 720 may be determined in accordance with the threshold length and the length of the report received upon receiving 710. In accordance with selecting the number of verification information based on a length of a report, presentation and review of different portions of the report may be enabled. The different portions may also be provided while enabling efficient insertion, review, and other processing of the verification information in a modified report comprising the verification information.

In embodiments, verification information may be inserted into a report. For example, method 700 may comprise inserting 730 verification information to generate a modified report. The verification information may comprise verification information selected upon selecting 720. Inserting 730 may comprise inserting at least one verification information in the draft report. The verification information may comprise at least one verification information selected from a plurality of verification information. Inserting 730 may comprise modifying text information in the draft report. For example, inserting 730 may comprise adding text information of the verification information after a first portion of text information in the draft report and prior to a second portion of text information in the draft report. Inserting 730 may comprise generating a modified report comprising a combination of the draft report and verification information inserted upon inserting 730. In accordance with inserting 730, embodiments according to various aspects may enable verification that a portion of the draft report proximate to inserted verification information has been provided to an end user. Verification may be enabled for at least a portion of the draft report prior to a location in the draft report at which the verification information is inserted upon inserting 730.

In embodiments, inserting 730 may comprise tracking the inserted verification information that has been inserted. For example, inserting 730 may comprise generating an array, list, or other logical indication of one or more verification information that have been inserted into a draft report. In accordance with tracking the inserted verification information, subsequent processing may be performed to determine whether the inserted verification information is revised in one or more operations subsequent to inserting 730.

In embodiments, inserting 730 may comprise inserting the verification information at a relative location within the draft report to generate the modified report. The relative location may comprise a location within the draft report relative to a reference location within the draft report. The reference location may comprise one of a beginning of the draft report, an end of the draft report, and a location at which another verification information has been inserted in the report. The relative location may be a predetermined distance away from the reference location. For example, the relative location may comprise a distance from the reference location. The distance may comprise a minimum distance. The distance may comprise an amount of text information. The distance may correspond to a number of words, sentences, or other logical units of written description away from the reference location. The distance may comprise a number of tokens away from the reference location. For example, the threshold distance may comprise a minimum number of sentences. For example, the threshold distance may comprise at least two sentences. Inserting 730 may comprise inserting verification information in the draft report at a relative location that is separated at least the distance from a reference location. Inserting 730 may comprise inserting verification information in the draft report at a relative location that is separated at least the distance from a plurality of reference locations.

In embodiments, a modified report may be provided. The modified report may comprise a report generated upon inserting 730. For example, method 700 may comprise providing 740 a modified report. Providing 740 may comprise transmitting the modified report to another computing device. For example, remote computing device 140 may generate a modified report upon inserting 730. Providing 740 may comprise remote computing device 140 transmitting the modified report to client computing device 170 for display. In embodiments, providing 740 may comprise one or more operations of providing 340 with brief reference to FIG. 3.

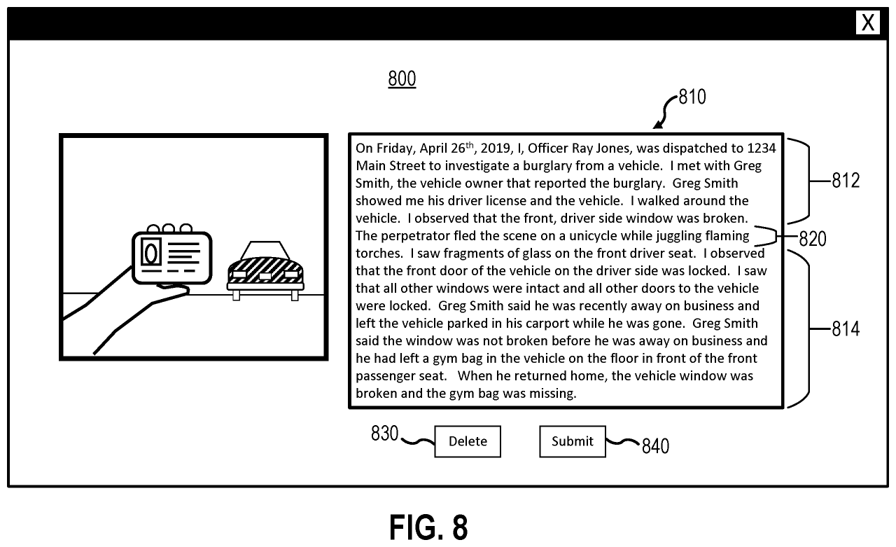

In embodiments, providing 740 may comprise displaying the modified report. For example, providing 740 may comprise displaying text information of the modified report on an output device of client computing device 170. Providing 740 may comprise providing the modified report via a user interface. For example, providing 740 may comprise providing the modified report via a user interface comprising user interface 800 with brief reference to FIG. 8. User interface 800 may comprise various elements. For example, a user interface for providing 740 according to various aspects of the present disclosure may comprise one or more of text display element 810, first user control element 830, and/or second user control element 840. Text display element 810 may correspond to, and perform one or more operations of, text display element 410 with brief reference to FIG. 4. Providing 740 may comprise visibly outputting the modified report via text display element 810. Text display element 810 may be configured to display a modified report to an end user. For example, a modified report comprising first portion 812 of a draft report, verification information 820, and second portion 814 of the draft report may be displayed via text display element 810.

In embodiments, text display element 810 may comprise an editable user interface element. For example, each of first portion 812 and second portion 814 of a draft report may be edited via text display element 810. Verification information 820 may also be edited in accordance with one or more inputs provided for text display element 810. Providing 740 may comprise providing the modified report in an editable manner. Providing 740 may comprise enabling portions of the modified report to be added, deleted, or otherwise further modified after being provided. In some embodiments, text display element 810 may comprise a text box in which the modified report may be provided for editing by an end user.

In embodiments, providing 740 may comprise receiving a revision of the modified report. The revision may be received in accordance with a manual input. The modified report may be manually revised in accordance with one or more operations associated with a user interface by which the modified report is provided prior to the revision being received. For example, the revision may comprise deletion of verification information from the modified report. Deletion of the verification may comprise selection of the verification information. Deletion of the verification may comprise an instruction to delete the verification information. For example, activation of first user control element 830 may cause a selected portion of the modified report to be removed from the modified report. The selected portion may comprise verification information 820. In other embodiments, the selected portion may comprise part of first portion 812 or second portion 814 of the draft report. In accordance with receiving the revision, an accuracy of the report relative to an incident may be improved or otherwise confirmed. In embodiments, receiving the revision may comprise one or more operations of receiving 370 with brief reference to FIG. 3.

In embodiments, a revision may be required prior to one or more subsequent operations for a draft report. For example, method 700 may comprise determining 750 whether verification information has been revised. Determining 750 may be performed by at least one computing device. For example, remote computing device 140 and/or client computing device 170 may perform one or more operations for determining 750 in accordance with various aspects of the present disclosure. In embodiments, determining 750 may comprise determining verification information has been revised or determining the verification information remains unrevised in the modified report.

In accordance with determining 750 indicating that a revision has not been received, determining 750 may be repeated. Determining 750 may be repeated until the revision is received. When a required revision has not been received, an alert may be generated. For example, a visual indication may be added or otherwise provided via user interface 800 when a required revision has not been received. Alternately or additionally, one or more operations of a computing device may be disabled when a revision has not been received. For example, second user control element 840 may be usable to submit a revised report for storage. Second user control element 840 may enable a revised report to be transmitted from client computing device 170 for storage in data store 150 second control element. In embodiments, second user control element 840 may be disabled when a revision has not been received.

In embodiments, determining 750 may comprise comparing a revised report to tracked information regarding verification information. The tracked information may identify verification information inserted upon inserting 730. For example, the tracked information may comprise a list of one or more verification information added to a draft report upon inserting 730. Determining 750 may comprise determining whether tokens or other text information associated with verification information have been removed from text data associated with a revised report. Determining 750 may require that all verification information added to a draft report is revised. Determining 750 may comprise indicating that a revision has not been received when at least one required revision of a plurality of revisions required for a modified report has not been received.

In embodiments, determining 750 may comprise determining the verification information has been revised. Determining the verification information of the modified report has been received may comprise determining the verification information has been deleted from the modified report to generate a revised report. In accordance with determining the verification information has been revised, embodiments according to various aspects of the present disclosure may provide a technical benefit of ensuring that report information proximate to the verification information has been displayed. Such a technical benefit may be particularly critical for different types of output devices associated with a client computing device. For example, client computing device 170 may comprise a smartphone or a laptop with different types of display devices. Particularly, different types of client computing devices may comprise different sizes of display upon which a draft report may be displayed. In accordance with receiving a revision to a report, embodiments of the present disclosure may ensure that different portions of a draft report have been provided for display, independent of a size of a display device on which the draft report is presented. As a further benefit, in some embodiments, the draft report may be further directly edited via a same user interface upon which the verification information is presented prior to revision.

In accordance with determining 750 indicating that verification information has been revised. Determining that the verification information has been revised may comprise detecting that each verification information inserted in a draft report has been identified after being provided. Determining that the verification information has been revised may comprise detecting that each verification information inserted in a draft report has been deleted. In embodiments, when one or more required revisions have been received, an alert may be disabled. For example, a visual indication may be removed from user interface 800 when all required revisions have been received. Alternately or additionally, one or more operations of a computing device may be enabled when the verification information has been revised. For example, second user control element 840 may be enabled when revision(s) are determined to have been received in accordance with determining 750.

In embodiments, a revised report may be submitted. The submitted, revised report may provide documentation of an incident for subsequent review. For example, method 700 may comprise submitting 760 a revised report. The revised report may be available for submission in accordance with determining that verification information previously provided in the report has been revised upon determining 750. Submitting 760 may comprise transmitting the revised report for storage. For example, client computing device 170 and/or remote computing device 140 may submit a revised report to data store 150 for further storage. Upon submission of a report, the revised report may no longer be editable. Submitting the revised report may render the revised report uneditable. According to various aspects of the present disclosure, submitting 760 may comprise applying read-only access permissions to the revised report. By preventing further editing of the revised report, a description of an incident generated at a point of time near when the incident occurred may be preserved for future reference. The revised report may be preserved for future review of the incident and/or one or more actions that occurred during the incident.

In embodiments, submitting 760 may comprise receiving an instruction to submit the revised report. For example, user interface 800 may comprise second user control element 840. Second user control element 840 may be distinct from first user control element 830. In accordance with an actuation of second user control element 840, an instruction to submit a report displayed in text display element 810 may be received. Responsive to receiving the instruction, report information presented via text display element 810 may be transmitted or otherwise preserved on one or more computing devices for subsequent review in association with an incident for which the draft report was initially generated.

In some aspects, the techniques described herein relate to a computer-implemented method including: generating, by at least one computing device, a report describing audio data captured at an incident; receiving, by the at least one computing device, a selection of a subset of the report; and in accordance with the selection, identifying, by the at least one computing device, a subset of the audio data for playback, wherein: generating the report includes generating the report using a pre-trained, generative machine learning model executed by the at least one computing device; the report includes text data associated with different portions of the audio data; and the subset of the report was generated based on the subset of the audio data.

In some aspects, the techniques described herein relate to a method, wherein generating the report includes receiving the audio data from a remote computing device.

In some aspects, the techniques described herein relate to a method, wherein the remote computing device includes a wearable camera or a vehicle mounted camera.

In some aspects, the techniques described herein relate to a method, wherein generating the report includes transcribing the audio data to generate a transcript of the audio data.

In some aspects, the techniques described herein relate to a method, wherein generating the report includes applying the generative machine learning model to the transcript.

In some aspects, the techniques described herein relate to a method, wherein receiving the selection includes providing the report for display via user interface.

In some aspects, the techniques described herein relate to a method, wherein receiving the selection includes receiving the selection via a user interface.

In some aspects, the techniques described herein relate to a method, wherein receiving the selection includes modifying a visual appearance of the subset of the report presented via the display.

In some aspects, the techniques described herein relate to a method, wherein the subset of the report includes text data associated with a sentence of the report.

In some aspects, the techniques described herein relate to a method, wherein identifying the subset of the audio data includes providing a progress bar that visually indicates a duration of the audio data and a playback location within the duration of the audio data.

In some aspects, the techniques described herein relate to a method, wherein identifying the subset of the audio data includes positioning the playback location at a beginning of the subset of the audio data.

In some aspects, the techniques described herein relate to a method, wherein positioning the playback location includes repositioning the playback location from a first location along the progress bar to a second location along the progress bar.

In some aspects, the techniques described herein relate to a method, wherein identifying the subset of the audio data includes selecting a starting frame within the audio data at which playback is subsequently commenced.

In some aspects, the techniques described herein relate to a method, wherein identifying the subset includes receiving, from the generative machine learning model, an indication of a portion of a transcript of the audio data upon which the subset of the report was generated.

In some aspects, the techniques described herein relate to a method, wherein identifying the subset includes identifying a timestamp associated with the portion of the transcript, wherein the timestamp indicates a chronological location in the audio data including an audio signal from which the portion of the transcript was transcribed.

In some aspects, the techniques described herein relate to a method, wherein identifying the subset includes selecting the portion of the audio data associated with the timestamp.

In some aspects, the techniques described herein relate to the method of any one of the above, wherein generating the report includes generating a narrative portion of the report.

In some aspects, the techniques described herein relate to a computer-implemented method of generating a report for an incident, the method including: storing, by at least one computing device, a plurality of sample reports in a reference data store; receiving, by the at least one computing device, audio data captured at an incident and an input incident type associated with the incident; selecting a sample report of the plurality of sample reports in accordance with the input incident type; and generating, by the at least one computing device, the report based on the audio data and the sample report of the plurality of sample reports.

In some aspects, the techniques described herein relate to a method, wherein, each sample report of the plurality of sample reports is associated with an incident type of a plurality of incident types.

In some aspects, the techniques described herein relate to a method, wherein selecting the sample report includes determining the incident type associated with the sample report corresponds to the input incident type.

In some aspects, the techniques described herein relate to a method, wherein storing the plurality of sample reports includes storing the plurality of sample reports prior to receiving the transcript of the audio data.

In some aspects, the techniques described herein relate to a method, wherein the plurality of incident types includes at least one of an assault, battery, damage to property, traffic accident, and theft.

In some aspects, the techniques described herein relate to a method, wherein each incident type of the plurality of incident types is associated with a unique offense code.

In some aspects, the techniques described herein relate to a method, wherein the plurality of sample reports includes a first sample report with a first incident type and a second sample report associated with a second incident type of the plurality of incident types, the first sample report different from the second sample report and the first incident type different from the second incident type.

In some aspects, the techniques described herein relate to a method, further including receiving, by the at least one computing device, the audio data.

In some aspects, the techniques described herein relate to a method, wherein receiving the transcript includes transcribing, by the at least one computing device, the audio data to generate a transcript.

In some aspects, the techniques described herein relate to a method, wherein generating the report includes applying the generative machine learning model to the transcript.

In some aspects, the techniques described herein relate to a method, wherein: the reference data store is associated with a user identifier of a plurality of user identifiers; selecting the sample report includes selecting the sample report in accordance with the user identifier, wherein each user identifier of the plurality of user identifiers is associated with a different reference data store including a different plurality of sample reports.

In some aspects, the techniques described herein relate to a method, wherein each user identifier of the plurality of user identifiers is associated with a different agency of a plurality of different agencies.

In some aspects, the techniques described herein relate to a method, wherein selecting the sample report includes matching the input incident type with an incident type associated with the sample report.

In some aspects, the techniques described herein relate to a method, wherein the matching includes matching a unique code of the input incident type with a unique code of the incident type of the sample report.

In some aspects, the techniques described herein relate to a method, wherein receiving the input incident type includes automatically detecting the input incident type from at least one of the audio data and/or a transcript of the audio data.

In some aspects, the techniques described herein relate to a method, further including providing, by the at least one computing device, the report for display via a user interface.

In some aspects, the techniques described herein relate to a method, wherein providing the report for display includes providing the report in an editable format.

In some aspects, the techniques described herein relate to a method, wherein providing the report for display includes receiving, by the at least one computing device, a revision to the report via the user interface.

In some aspects, the techniques described herein relate to a method, wherein generating the report includes generating a narrative portion of the report.

In some aspects, the techniques described herein relate to a computer-implemented method of generating a report for an incident, the method including: storing, by at least one computing device, predetermined instructions for generating a report in a computer-readable storage medium; receiving, by the at least one computing device, a transcript of audio data captured at an incident; generating a prompt including the predetermined instructions and the transcript; and responsive to submitting the prompt to a generative computing device, receiving an automatically generated report based on the predetermined instructions and the transcript.

In some aspects, the techniques described herein relate to any one of the above claims, further including automatically inserting verification information in the report.

In some aspects, the techniques described herein relate to the above claim, further including requiring revision of the verification information prior to transmission and/or storage of the report.

In some aspects, the techniques described herein relate to a computing device including at least one processor and at least one non-transitory, computer-readable storage medium storing instructions that, when executed by the processor, cause the computing device to perform one or more operations disclosed herein.

In some aspects, the techniques described herein relate to a non-transitory, computer-readable storage medium storing instructions that, when executed by a processor of a computing device, cause the computing device to perform one or more operations disclosed herein.

In some aspects, the techniques described herein relate to a computer-implemented method of generating a report for an incident, the method including: inserting, by at least one computing device, verification information in a draft report to generate a modified report; providing, by the at least one computing device, the modified report; and receiving, by the at least one computing device, a revision associated with the verification information, wherein the draft report is generated by generative computing device.

In some aspects, the techniques described herein relate to a computer-implemented method, further including receiving, by a computing device, the draft report from a generative computing device.

In some aspects, the techniques described herein relate to a computer-implemented method, further including: generating, by the generative computing device, the draft report based on a transcript of audio data associated with an incident.

In some aspects, the techniques described herein relate to a computer-implemented method, wherein the audio data is captured by one of a wearable camera, a wearable audio recorder, or a vehicle-mounted recording device.

In some aspects, the techniques described herein relate to a computer-implemented method, further including selecting, by the at least one computing device, the verification information.

In some aspects, the techniques described herein relate to a computer-implemented method, wherein selecting the verification information includes selecting the verification information from a plurality of predetermined verification.

In some aspects, the techniques described herein relate to a computer-implemented method, wherein the verification information includes predetermined text information.

In some aspects, the techniques described herein relate to a computer-implemented method, wherein the verification information is determined independent of the draft report.

In some aspects, the techniques described herein relate to a computer-implemented method, wherein inserting the verification information includes selecting a number of the verification information for insertion into the draft report.

In some aspects, the techniques described herein relate to a computer-implemented method, wherein selecting the number includes selecting the number in accordance with a length of the draft report.

In some aspects, the techniques described herein relate to a computer-implemented method, wherein the revision includes a deletion of the verification information from the draft report to provide a revised report.

In some aspects, the techniques described herein relate to a computer-implemented method, further including submitting, by the at least one computing device, the revised report.

In some aspects, the techniques described herein relate to a computer-based system, including: a remote computing device configured to perform first operations, including: inserting verification information in a draft report to generate a modified report; and providing the modified report; and a client computing device configured to perform second operations, including: receiving the modified report from the remote computing device; and receiving a revision associated with the verification information in the modified report, wherein the draft report is generated by generative computing device.

In some aspects, the techniques described herein relate to a computer-based system, further including a recording device, wherein the draft report is generated in accordance with audio data captured by the recording device.

In some aspects, the techniques described herein relate to a computer-based system, wherein the recording device includes one of a wearable recording device or a vehicle-mounted camera.

In some aspects, the techniques described herein relate to a computer-based system, wherein the first operations further include selecting, by the at least one computing device, the verification information.

In some aspects, the techniques described herein relate to a computer-based system, wherein selecting the verification information includes selecting the verification information from a plurality of predetermined verification.

In some aspects, the techniques described herein relate to a computer-based system, wherein the verification information includes predetermined text information.

In some aspects, the techniques described herein relate to a computer-based system, wherein the verification information is determined prior to generation of the draft report by the generative computing device.

In some aspects, the techniques described herein relate to a computer-based system, wherein inserting the verification information includes selecting a number of the verification information for insertion into the draft report in accordance with a length of the draft report.

In some aspects, the techniques described herein relate to a computer-based system, wherein inserting the verification information includes inserting a plurality of verification information; and receiving the revision includes receiving, via a user interface of the client computing device, an instruction to delete each verification information of the plurality of verification information from the draft report to provide a revised report.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computer-implemented method of generating a report for an incident, the method comprising:
storing, by at least one computing device, predetermined instructions for generating the report in a computer-readable storage medium;
receiving, by the at least one computing device, a transcript of audio data captured at the incident;
generating a prompt comprising the predetermined instructions and the transcript; responsive to submitting the prompt to a generative computing device, receiving the report; and
automatically inserting verification information in the report, wherein the report is automatically generated by the generative computing device based on the predetermined instructions and the transcript, and wherein the verification information is determined prior to generation of the report by the generative computing device.

2. The computer-implemented method of claim 1, wherein the audio data is captured by one of a wearable camera, a wearable audio recorder, or a vehicle-mounted recording device.

3. (canceled)

4. (canceled)

5. The computer-implemented method of claim 1, further comprising requiring revision of the verification information prior to transmission and/or storage of the report.

6. The computer-implemented method of claim 1, wherein the prompt comprises a sample report and generating the prompt comprises selecting the sample report from a plurality of sample reports in accordance with an incident type.

7. The computer-implemented method of claim 1, wherein the predetermined instructions include one or more rules for transforming the transcript into the report by the generative computing device.

8. (canceled)

9. A computing device comprising at least one processor and at least one non-transitory, computer-readable storage medium storing instructions that, when executed by the processor, cause the computing device to perform operations comprising:
storing predetermined instructions for generating a report in the computer-readable storage medium;
receiving a transcript of audio data captured at an incident;
generating a prompt comprising the predetermined instructions and the transcript;
transmitting the prompt to a generative computing device; and
responsive to transmitting the prompt to the generative computing device, receiving an automatically generated report from the generative computing device, wherein the automatically generated report is generated based on the prompt using a pre-trained, generative machine learning model executed by the generative computing device, and wherein the operations further comprise:
inserting verification information in the automatically generated report to generate a modified report;
providing the modified report to a client computing device; and
receiving, from the client computing device, a revision associated with the verification information.

10. (canceled)

11. The computing device of claim 9, wherein the operations further comprise selecting the verification information from a plurality of predetermined verification information.

12. The computing device of claim 9, wherein the verification information is determined independent of the automatically generated report.

13. The computing device of claim 9, wherein the revision comprises a deletion of the verification information from the modified report to provide a revised report.

14. The computing device of claim 13, further comprising submitting the revised report to a data store, wherein submitting the revised report comprises applying read-only access permissions to the revised report.

15-20. (canceled)

21. A computer-implemented method of generating a report for an incident, the method comprising:
storing, by at least one computing device, predetermined instructions for generating the report in a computer-readable storage medium;
receiving, by the at least one computing device, a transcript of audio data captured at the incident;
generating a prompt comprising the predetermined instructions and the transcript;
responsive to submitting the prompt to a generative computing device, receiving the report;
automatically inserting verification information in the report; and
requiring revision of the verification information prior to transmission and/or storage of the report, wherein the report is automatically generated by the generative computing device based on the predetermined instructions and the transcript.

22. The computer-implemented method of claim 21, wherein the audio data is captured by one of a wearable camera, a wearable audio recorder, or a vehicle-mounted recording device.

23. The computer-implemented method of claim 21, wherein the prompt comprises a sample report and generating the prompt comprises selecting the sample report from a plurality of sample reports in accordance with an incident type.

24. The computer-implemented method of claim 21, wherein the predetermined instructions include one or more rules for transforming the transcript into the report by the generative computing device.

25. The computer-implemented method of claim 21, comprising:
receiving, by the at least one computing device, a selection of a subset of the report; and
in accordance with the selection, identifying, by the at least one computing device, a subset of the audio data for playback, wherein:
the report comprises text data associated with different portions of the audio data; and
the subset of the report was generated based on the subset of the audio data.

26. The computer-implemented method of claim 21, further comprising selecting, by the at least one computing device, the verification information from a plurality of predetermined verification.

27. The computer-implemented method of claim 21, wherein the verification information comprises predetermined text information.

28. The computer-implemented method of claim 21, wherein the verification information is determined independent of the report.

29. The computer-implemented method of claim 21, further comprising submitting, by the at least one computing device, a revised report, wherein the revision comprises a deletion of the verification information from the report to provide the revised report.

30. The computer-implemented method of claim 21, wherein inserting the verification information comprises selecting a number of the verification information for insertion into the report, and wherein selecting the number comprises selecting the number in accordance with a length of the report.
